(19) United States
(12) Patent Application Publication
(10) Pub. No.: US 2009/0063848 A1
(43) Pub. Date: Mar. 5, 2009

(54) METHOD AND SYSTEM FOR SENDING/RECEIVING DATA, CENTRAL APPARATUS, AND COMPUTER READABLE STORAGE MEDIUM THEREOF

(75) Inventors: Yutaka Iwayama, Kawasaki (JP); Tatsuro Matsumoto, Kawasaki (JP); Kazuo Sasaki, Kawasaki (JP); Masayuki Fukui, Kawasaki (JP); Ai Yano, Kawasaki (JP); Eiichi Takahashi, Kawasaki (JP); Masahiro Hara, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/202,730

(22) Filed: Sep. 2, 2008

(30) Foreign Application Priority Data
Sep. 5, 2007 (JP) 2007-230590

(51) Int. Cl. H04L 9/00

(52) U.S. Cl. 713/150

(57) ABSTRACT

A product data category for sale among product data to be stored in a memory unit of a wireless tag is sent from a first client to a web server. The web server sends the product data category to a second client. The second client sends purchase data for the product data category to the web server. The web server sends an encryption key to the first client. The first client encrypts the product data with the encryption key and writes the encrypted product data in the memory unit of the wireless tag via a reader/writer. The web server sends a decryption key to the second client. On receiving the decryption key, the second client reads the encrypted product data in the wireless tag via a reader/writer to decrypt the encrypted product data with the decryption key.

### BACKGROUND OF THE INVENTION

1. Field of the Invention

The present invention relates to a method executed by a central apparatus for sending/receiving data about a memory unit of a wireless tag to/from in response to a request from a terminal device connected to the central apparatus through a communication network.

2. Description of the Related Art

In the field of logistics, the wireless tag is attached to a product and data is read from or written on the memory unit of the wireless tag with a reader/writer for merchandise control. The wireless tags, replacing barcodes, have been rapidly popularized in logistics and used for various purposes, as well as the logistics (for example, see Japanese Laid-open Patent Publication No. 2001-307055).

The memory unit of the wireless tag stores product data including various product names, prices, manufacturer names, as well as unique identification data. The product data stored in the wireless tag is read with a reader/writer by a dealer for inventory control. The wireless tags are handled by multiple traders in logistics. For example, in food distribution, a food manufacturer at an upstream stage attaches wireless tags to products and delivers the products to each retailer at a downstream stage. Each retailer receives the products from the food manufacturer and sells the products with the wireless tags.

However, in some cases, other product data is required in addition to the product data stored in the memory unit of the wireless tag. For example, the retailer may require product data such as production date, person in charge, use-by date, or ingredients of the product (food) in addition to the product name, price, and manufacturer stored in the memory unit of the wireless tag. This issue can be solved by storing all product data in the memory unit of the wireless tag, but a capacity of the memory unit is restricted. Under such circumstances, it becomes a problem to determine which product data should be stored in the wireless tag with efficiency.

Further, effective utilization of the free area in the memory unit of the wireless tag, that is, the excess area other than the area filled with various data, is worthy of consideration. The technique discussed in Japanese Laid-open Patent Publication No. 2001-307055 assigns a memory section to each distribution stage in advance and gives no solution to the above problem.

### SUMMARY

It is an object of the present invention to provide a sending/receiving method executed by a central apparatus as a trading intermediary for effective utilization of the memory area of the memory unit in the wireless tag.

According to one aspect of the present invention, provided is a method executed by a system including terminal devices and a central apparatus connected to the terminal devices through a communication network. The central apparatus sends and receives data in accordance with a request from one of the terminal devices. The method includes the following operations. A first terminal device sends to the central apparatus first data indicating a first category of data for sale among categories of data to be stored in a memory unit of a wireless tag. The central apparatus sends the first data to a second terminal device. The second terminal device sends second data indicating purchase of data of the first category. The central apparatus sends an encryption key to the first terminal device on receiving the second data. The first terminal device encrypts the data of the first category with the encryption key and writes encrypted data of the first category to the memory unit of the wireless tag. The central apparatus sends a decryption key to the second terminal device. The second terminal device reads the encrypted data of the first category from the memory unit of the wireless tag and decrypts the encrypted data of the first category with the decryption key.

The method may further include the following operations. The first terminal device sends third data indicating a memory area for sale within the memory unit of the wireless tag. The central apparatus sends the third data to the second terminal device. The second terminal device sends fourth data indicating purchase of the memory area. The central apparatus sends a restriction key to the first terminal device on receiving the fourth data. The first terminal device restricts a write access to the memory area with the restriction key. The central apparatus sends a cancel key to the second terminal device. The second terminal device cancels the restriction of a write access to the memory area with the cancel key.

The central apparatus may send the first data (or third data) to other terminal devices as well as the second terminal device for bidding. Then, each of the second terminal device and other terminal devices sends a bid price to the central apparatus. When a deadline date expires, the central apparatus determines a winner with the highest bid price and sends the decryption key (or the cancel key) to the winner.

The first terminal device may send to the central apparatus a price data indicating an asking price for the data of the first category (or a memory area) as well as the first data (or the third data). Then, the central apparatus sends to the second terminal device the asking price as well as the first data (or the third data).

The second terminal device may send to the central apparatus fifth data indicating a second category of data desired. Then, the central apparatus sends the fifth data to the first terminal device.

### BRIEF DESCRIPTION OF THE DRAWINGS

FIG. 1 is a schematic diagram illustrating a sending/receiving system according to a first embodiment of the present invention;

FIG. 2 is a block diagram illustrating a hardware configuration of a wireless tag according to a first embodiment of the present invention;

FIG. 3 is a block diagram illustrating a hardware configuration of the client 1 according to a first embodiment of the present invention;

FIG. 4 is a diagram illustrating a record layout of the product data DB 161 according to a first embodiment of the present invention;

FIG. 5 is a diagram illustrating a record layout of the address file 154 according to a first embodiment of the present invention;

FIG. 6 is a diagram illustrating a record layout of the sales history file 155 according to a first embodiment of the present invention;

FIG. 7 is a block diagram illustrating a hardware configuration of the client 2 according to a first embodiment of the present invention;

FIG. 8 is a block diagram illustrating a hardware configuration of the web server 5 according to a first embodiment of the present invention;

FIG. 9 is a diagram illustrating a record layout of the user data file 551 according to a first embodiment of the present invention;

FIG. 10 is a diagram illustrating a screen image for a registration of product data for sale according to a first embodiment of the present invention;

FIG. 11 is a diagram illustrating a record layout of the first sales history DB 552 according to a first embodiment of the present invention;

FIG. 12 is a diagram illustrating a screen image for a purchase of product data according to a first embodiment of the present invention;

FIG. 13 is a diagram illustrating a screen image for a registration of an area for sale according to a first embodiment of the present invention;

FIG. 14 is a diagram illustrating a record layout of the second sales history DB 557 according to a first embodiment of the present invention;

FIG. 15 is a diagram illustrating a screen image for a purchase of an area for sale according to a first embodiment of the present invention;

FIGS. 16 and 17 are diagrams illustrating a flowchart of a registration process of product data for sale according to a first embodiment of the present invention;

FIGS. 18 to 20 are diagrams illustrating a flowchart of an encryption and decryption process according to a first embodiment of the present invention;

FIGS. 21 and 22 are diagrams illustrating a flowchart of a registration process of an area for sale according to a first embodiment of the present invention;

FIGS. 23 to 25 are diagrams illustrating a flowchart of a purchase process of an area for sale, a write restriction process, and a write allowance process according to a first embodiment of the present invention;

FIG. 26 is a block diagram illustrating a hardware configuration of the web server 5 according to a second embodiment of the present invention;

FIG. 27 is a diagram illustrating a screen image for a purchase of an area for sale according to a second embodiment of the present invention;

FIG. 28 is a diagram illustrating a record layout of the price file 558 according to a second embodiment of the present invention;

FIG. 29 is a diagram illustrating a flowchart of a bidding process according to a second embodiment of the present invention;

FIGS. 30 and 31 are diagrams illustrating a flowchart of a send process of desired product data category according to a third embodiment of the present invention; and

FIG. 32 is a block diagram illustrating a hardware configuration of the web server 5 according to a fourth embodiment of the present invention.

### DESCRIPTION OF THE PREFERRED EMBODIMENTS

Embodiments of the present invention will be discussed hereinafter with reference to the accompanying drawings.

### First Embodiment

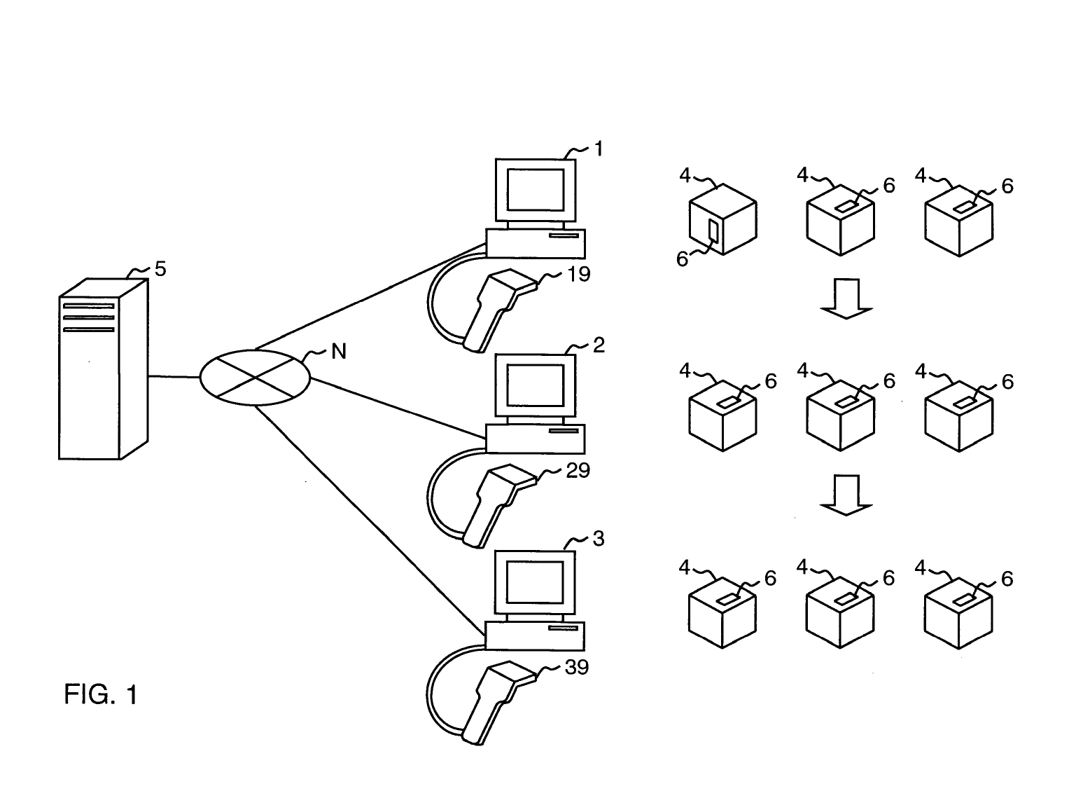

FIG. 1 is a schematic diagram illustrating a sending/receiving system according to a first embodiment of the present invention. The sending/receiving system includes a central apparatus (computer) 5, terminal devices 1, 2, 3 . . . , a communication network N, wireless tags 6, reader/writers 19, 29, 39 . . . , and products 4. The central apparatus 5 and the terminal devices 1, 2, 3 . . . are connected together via the communication network N such as the Internet to send/receive predetermined data in accordance with a protocol such as an HTTP (hyper text transfer protocol). Hereinafter, the central apparatus 5 and the terminal devices 1, 2, 3 . . . will be also referred to as a web server 5 and clients 1, 2, 3 . . . , respectively.

The client 1 is connected to the reader/writer 19 that reads/writes data from/to the wireless tag 6 attached to the product 4. The wireless tag 6 has an identifier and a rewritable area and includes but not restricted to an IC tag, an RFID (radio frequency identification), an IC card, or a rewritable barcode. In the following description, the product 4 is explained as a beer in a case attached with the wireless tag 6 by way of example. A beer producer who produces the beer 4 operates the client 1. A carrier who carries the beer 4 downstream of the beer producer operates the client 2. A retailer who retails the beer 4 downstream of the carrier operates the client 3.

Specific identification data (hereinafter referred to as “ID”) and basic data such as data of a producer and product name of the beer 4 are stored in the wireless tag 6. The reader/writer 19 writes the above data to the wireless tag 6. In addition, according to the first embodiment of the present invention, product data such as production date, which is necessary for the carrier or retailer positioned at the downstream site, is written to the wireless tag 6. The web server 5 intermediates trade of product data among the clients 1 to 3. The web server 5 also intermediates trade of an excess area in a memory unit of the wireless tag 6. For example, considering that the client 2 often requests to the client 1 the production date as product data about the beer 4, the total processing speed may be increased if the client 1 stores the production date in advance by way of the reader/writer 19.

In this case, the client 1 encrypts the production date and writes the encrypted data to the wireless tag 6 with the reader/writer 19. The client 2 of the carrier reads the production date from the wireless tag 6 with the reader/writer 29, and decrypts the read production date with a decryption key sent from the web server 5. On the other hand, as for an excess memory area, the client 1 restricts a write access to a memory area for sale within the excess memory area of the wireless tag 6 with a restriction key. The client 2 cancels the restriction on the write access to the memory area for sale in the wireless tag 6 with a cancel key. The above processing is similarly applied to multiple wireless tags 6, 6 . . . , and the product data and excess area in the multiple wireless tags 6, 6 . . . are also sold between the clients 1, 2, 3 . . . . For ease of explanation, in the following description, the product data and excess area in one wireless tag are sold between the clients 1 and 2.

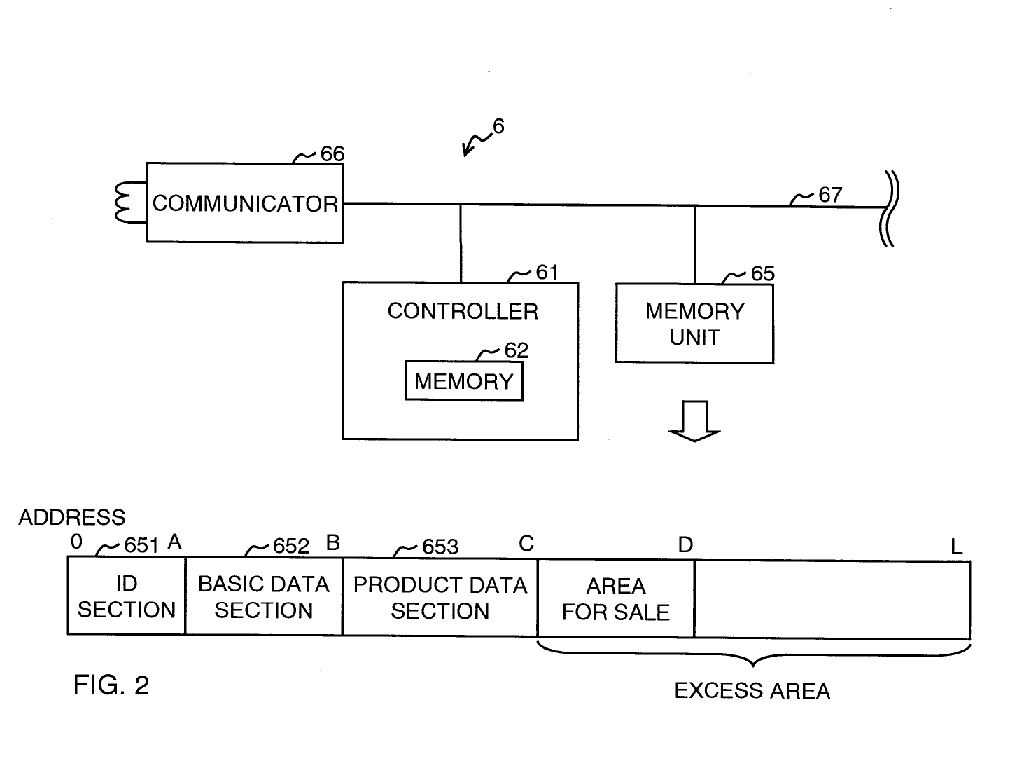

FIG. 2 is a block diagram illustrating a hardware configuration of a wireless tag according to a first embodiment of the present invention. The wireless tag 6 includes a controller 61, a communicator 66, and a memory unit 65. The controller 61 includes a logic circuit and a memory 62 and controls, in accordance with an internal program, the communicator 66 and the memory unit 65 connected via a transmission line 67. The communicator 66 includes a coil and an RF circuit for wireless communications, and sends/receives an ID, basic data, and product data to/from a reader/writer.

The memory unit 65 is constructed of, for example, an EEPROM (electronically erasable and programmable read only memory), an FeRAM (ferroelectric random access memory), or a flash ROM (read only memory), and includes an ID section 651, a basic data section 652, and a product data section 653, and an excess area including an area for sale. As shown in FIG. 2, the memory unit 65 includes a memory area for storing data between an address 0 to an address L. A memory area from the address 0 to an address A is the ID section 651, a memory area from an address A+1 to an address B is the basic data section 652, and a memory area from an address B+1 to an address C is the product data section 653. An area from an address C+1 to the address L is an excess area not storing any data. In the excess area, an area from the address C+1 to an address D is an area for sale from the client 1 to the client 2.

The ID section 651 stores a unique ID assigned to the wireless tag 6. The basic data section 652 stores basic data of the beer 4. The basic data includes data about a producer, product name (brand name), and number of bottles. These data are stored in the memory unit 65 of the wireless tag 6 with the reader/writer 19 under the control of the client 1. The ID and basic data stored in the ID section 651 and the basic data section 652 can be read with the reader/writers 29 and 39 of the clients 2 and 3 with no particular restrictions.

The product data section 653 stores encrypted product data for sale, such as the production date and container data of the beer 4. The container data is data about a container of the beer 4. For example, the product data section 653 stores data about whether the container of the beer 4 is a glass bottle or an aluminum can The excess area including the area for sale stores no data, and a write access thereto is restricted to prohibit a third person from freely writing data. The write restriction is controlled by the controller 61. On receiving addresses of the intended memory area for write restriction and a restriction key via the communicator 66, the controller 61 restricts, using the restriction key, a write access to the designated memory area.

On receiving a cancel key for cancelling the write restriction via the communicator 66, the controller 61 cancels the write restriction. As the restriction key and the cancel key, a common write password may be used, for example. In the following description, a common write password is used as the restriction key and the cancel key. Alternatively, different passwords may be set as the restriction key and the cancel key. In this case, association data between the restriction key and the cancel key may be stored in the memory 62 of the controller 61. On receiving addresses of the intended memory area for write restriction and a write password via the communicator 66, the controller 61 stores the write password and the addresses in the memory 62 for write restriction on the addresses. On receiving a write password via the communicator 66, the controller 61 determines whether the received write password matches with the write password in the memory 62. If matched, the controller 61 reads corresponding addresses and cancels the write restriction on the read addresses. If the received write password does not match with the write password in the memory 62 or no write password has been received, the controller 61 executes the write restriction on the addresses.

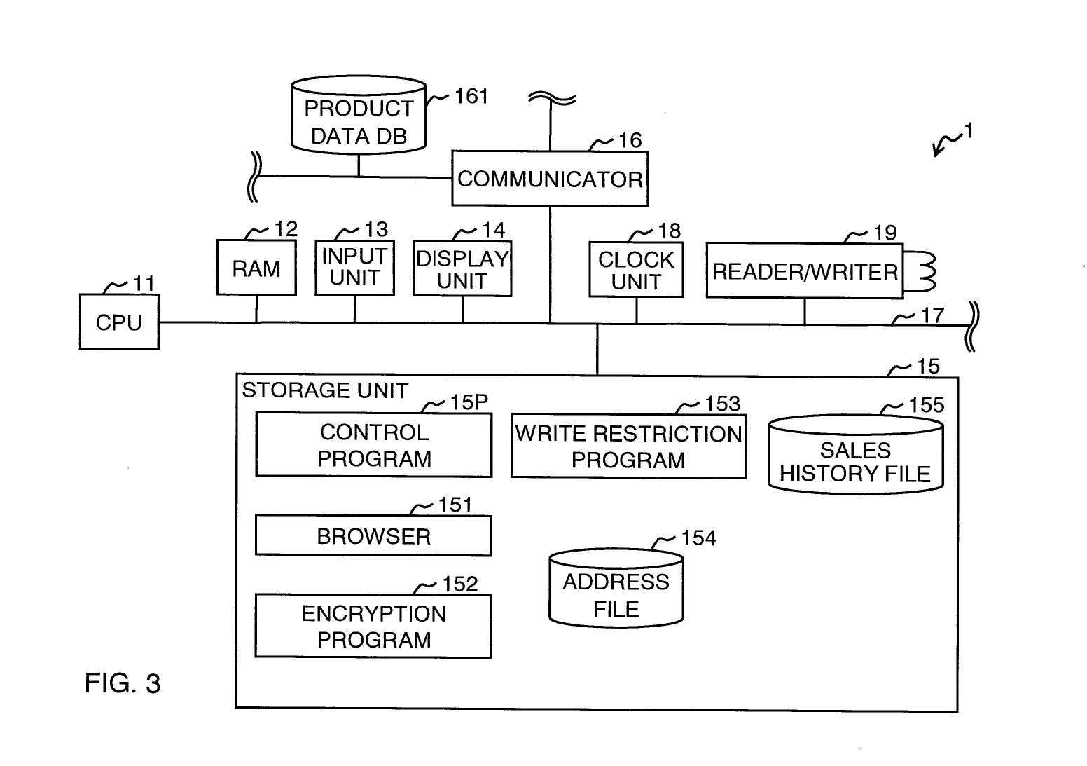

FIG. 3 is a block diagram illustrating a hardware configuration of the client 1 according to a first embodiment of the present invention. The client 1 includes a CPU (central processing unit) 11 as a controller, a RAM (random access memory) 12, an input unit 13, a display unit 14, a clock unit 18, a communicator 16, a product database (hereinafter product data DB) 161, the reader/writer 19, and a storage unit 15. The CPU 11 is connected to hardware components of the client 1 via a bus 17 and controls the hardware components. The CPU 11 also performs various software functions in accordance with a control program 15P, an encryption program 152, and a write restriction program 153.

The display unit 14 is, for example, a liquid crystal display. The input unit 13 includes a keyboard and a mouse. The communicator 16 is, for example, a gateway that serves as a firewall. The clock unit 18 outputs data of current date and time to the CPU 11. The storage unit 15 is, for example, a hard disk storing the control program 15P, an address file 154, and a sales history file 155. The CPU 11 is connected to the product data DB 161. The CPU 11 interacts with the product data DB 161 in a schema in which keys in fields thereof are associated with each other, through an access interface, such as an SQL (structured query language), corresponding to a format of a database to store or search for necessary data. The product data DB 161 referenced by the client 1 may be stored in the storage unit 15.

The client 1 is connected to the reader/writer 19 via an interface (not shown). Any known device can be used as the reader/writer 19. The reader/writer 19 sends toward the communicator 66 of the wireless tag 6 data to be written to the wireless tag 6 in accordance with an instruction from the CPU 11 of the client 1. Further, the reader/writer 19 receives data sent from the wireless tag 6 via the communicator 66. The received data is output to the client 1, and the CPU 11 of the client 1 executes predefined processing using the output data.

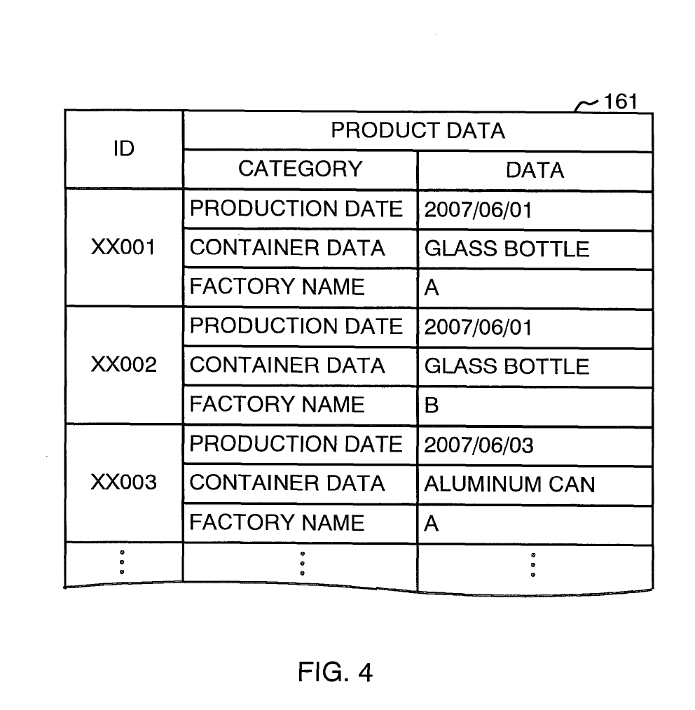

FIG. 4 is a diagram illustrating a record layout of the product data DB 161 according to a first embodiment of the present invention. A record of the product data DB 161 includes an “ID” field and a “product data” field. The “ID” field stores an ID assigned to each wireless tag 6. The “product data” field includes a “category” field and a “data” field. The “category” field stores a name of a product data category in association with the ID. The “data” field stores data on the product data category in association with the ID. The product data category includes production date, container data, and factory name, and the data in the “data” field is real data corresponding to the category. For example, product data stored in a wireless tag 6 having an ID of XX001 includes “2007, June 01” as production date, glass bottle as container data, and A as a factory name. Other basic data including a producer, a product name, and the number of bottles are stored in the storage unit 15.

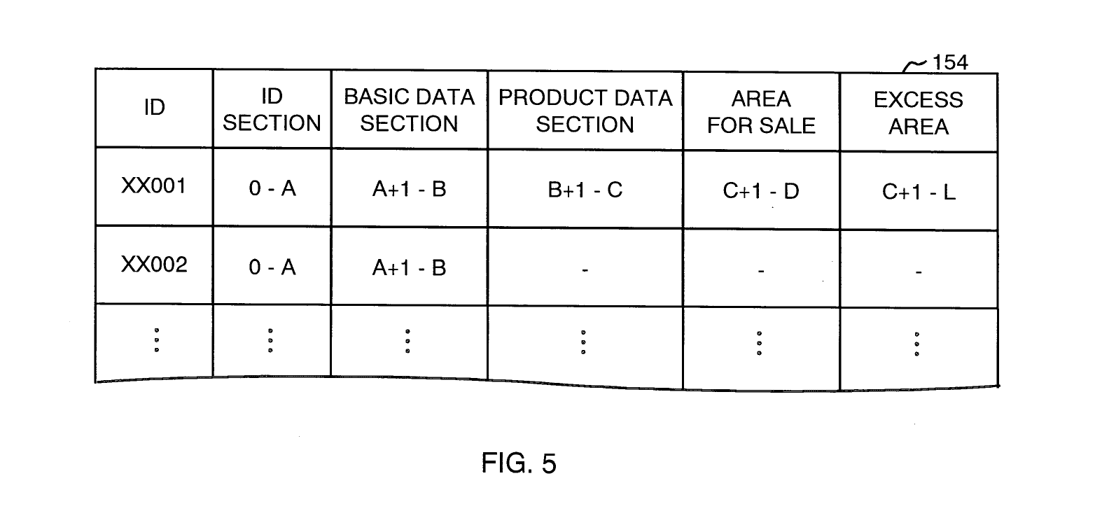

FIG. 5 is a diagram illustrating a record layout of the address file 154 according to a first embodiment of the present invention. A record of the address file 154 stores addresses assigned to various types of data in association with the ID. As shown in FIG. 2, as for a wireless tag 6 having an ID of XX001, for example, an area from the address 0 to the address A is a memory area of the ID section 651, an area from the address A+1 to the address B is a memory area of the basic data section 652, and an area from the address B+1 to the address C is a memory area of the product data section 653. An area from the address C+1 to the address L is an excess area not storing any data. In the excess area, an area from the address C+1 to the address D is an area for sale. The addresses corresponding to the ID section 651, the basic data section 652, the product data section 653, and the excess area may be input by a user with an appropriate value via the input unit 13 at the stage of design. As for the addresses of the area for sale, the user inputs appropriate values via the input unit 13 upon selling the intended area from the client 1 to the client 2. The CPU 11 stores the input addresses of the area for sale in the address file 154 as discussed below.

When the CPU 11 writes an ID and basic data to a wireless tag 6, the CPU 11 reads the ID and basic data from the storage unit 15. Further, the CPU 11 reads addresses of the ID section 651 corresponding to the read ID and addresses of the basic data section 652 corresponding to the read basic data, from the address file 154. The CPU 11 outputs the ID and basic data, and corresponding addresses to the reader/writer 19. The reader/writer 19 sends the output data to the communicator 66 of the wireless tag 6. The controller 61 references the received addresses corresponding to the ID, and stores the received ID in the ID section 651. Likewise, the controller 61 references the received addresses corresponding to the basic data, and stores the received basic data in the basic data section 652.

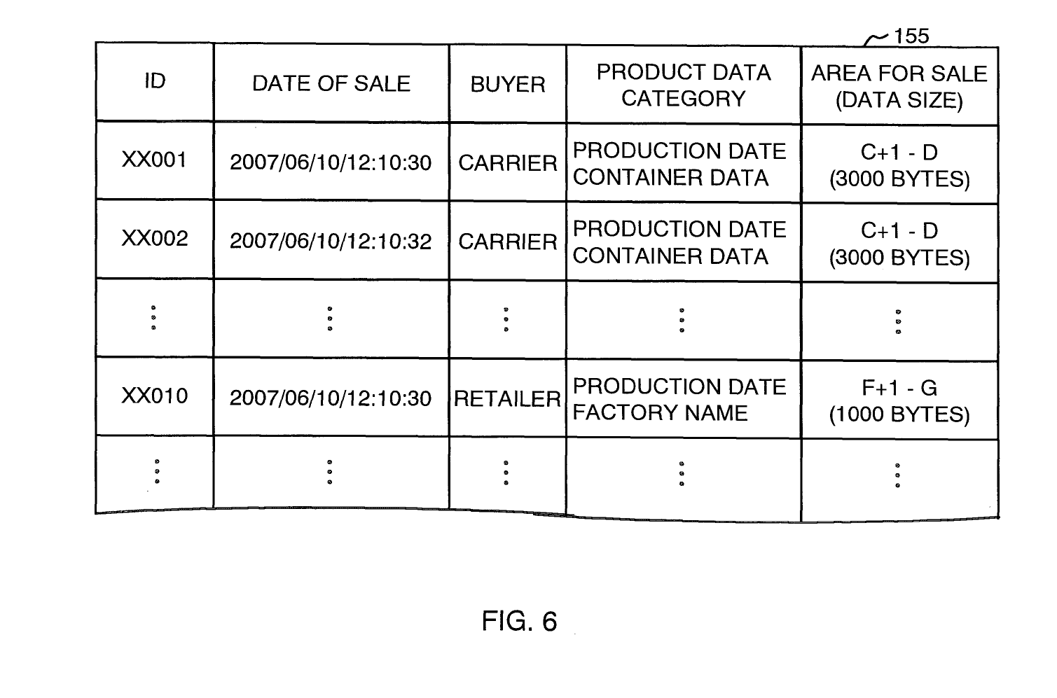

It is assumed in the first embodiment that the carrier purchases the production date and container data among three product data. FIG. 6 is a diagram illustrating a record layout of the sales history file 155 according to a first embodiment of the present invention. A record of the sales history file 155 includes an “ID” field, a “date of sale” field, a “buyer” field, a “product data category” field, and an “area for sale (data size)” field. The “date of sale” field stores the date and time when product data in a wireless tag 6 having an ID of XX001 was sold. The “buyer” field stores a name of a buyer who bought the product data. The “product data category” field stores the category of the sold product data.

Further, the “area for sale (data size)” field stores addresses of an area for sale within the excess area of the wireless tag 6 and a corresponding data size. According to the example shown in FIG. 6, for example, the carrier bought on Jun. 10, 2007, 12:10:30 the production date and container data among the product data stored in a wireless tag 6 having an ID of XX001. The carrier also bought an area for sale corresponding to 3000 bytes between the address C+1 and the address D out of the excess area. The CPU 11 stores encrypted product data in the product data section 653 when sales of product data is made between the web server 5, the client 2, and the client 3 as discussed below. The CPU 11 restricts a write access to the area for sale when sales of the area for sale is made between the web server 5, the client 2, and the client 3 as discussed below. The CPU 11 stores, in the sales history file 155, the data stored in the wireless tag 6.

The CPU 11 reads the data “2007/6/1” and “glass bottle” corresponding to the category “production date” and “container data” from the product data DB 161 when the CPU 11 writes the product data stored in a wireless tag 6 having an ID of XX001. The CPU 11 starts the encryption program 152 and encrypts the product data with an encryption key sent from the web server 5. The CPU 11 reads addresses of the product data section 653 from the address file 154, and outputs the read addresses and the encrypted product data to the reader/writer 19. In the first embodiment, the encryption/decryption method may be either a common key cryptosystem or a public key cryptosystem.

The communicator 66 of the wireless tag 6 receives the addresses and the encrypted product data sent from the reader/writer 19. The controller 61 stores the encrypted product data in the product data section 653 on the basis of the received addresses. In the case of restricting a write access, the CPU 11 starts the write restriction program 153, reads addresses of the area for sale from the address file 154, and outputs to the reader/writer 19 the read addresses and a write password sent from the web server 5.

The communicator 66 of the wireless tag 6 receives the addresses and the write password sent from the reader/writer 19. The controller 61 stores the received write password and addresses in the memory 62 and restricts a write access to the received addresses of the area for sale. Further, as discussed below, the controller 61 also restricts a write access to excess area except the area for sale, that is, area that has not been sold, with an auxiliary write password. The CPU 11 reads the auxiliary write password stored in the storage unit 15. The CPU 11 references the address file 154 and reads addresses of the excess area except addresses of the area for sale (in this example, address D+1 to address L). Then, the read addresses and auxiliary write password are sent to the reader/writer 19. The communicator 66 of the wireless tag 6 receives the addresses and auxiliary write password sent from the reader/writer 19. The controller 61 stores the received auxiliary write password and addresses in the memory 62 and restricts a write access to the received addresses of the excess area except the area for sale.

After that, when the communicator 66 of the wireless tag 6 receives an auxiliary write password sent from the reader/writer 19 that matches with the auxiliary write password stored in the memory 62, the controller 61 reads addresses stored in the memory 62 in association with the auxiliary write password and allows writing data to the addresses. On the other hand, when the communicator 66 of the wireless tag 6 receives an auxiliary write password sent from the reader/writer 19 that does not match with the auxiliary write password stored in the memory 62, or no auxiliary write password is sent from the reader/writer 19, the controller 61 does not allow writing data to the addresses corresponding to the auxiliary write password stored in the memory 62. A browser 151 stored in the storage unit 15 is used for trading product data and excess area with the web server 5, which is, for example, Microsoft Internet Explorer (registered trademark).

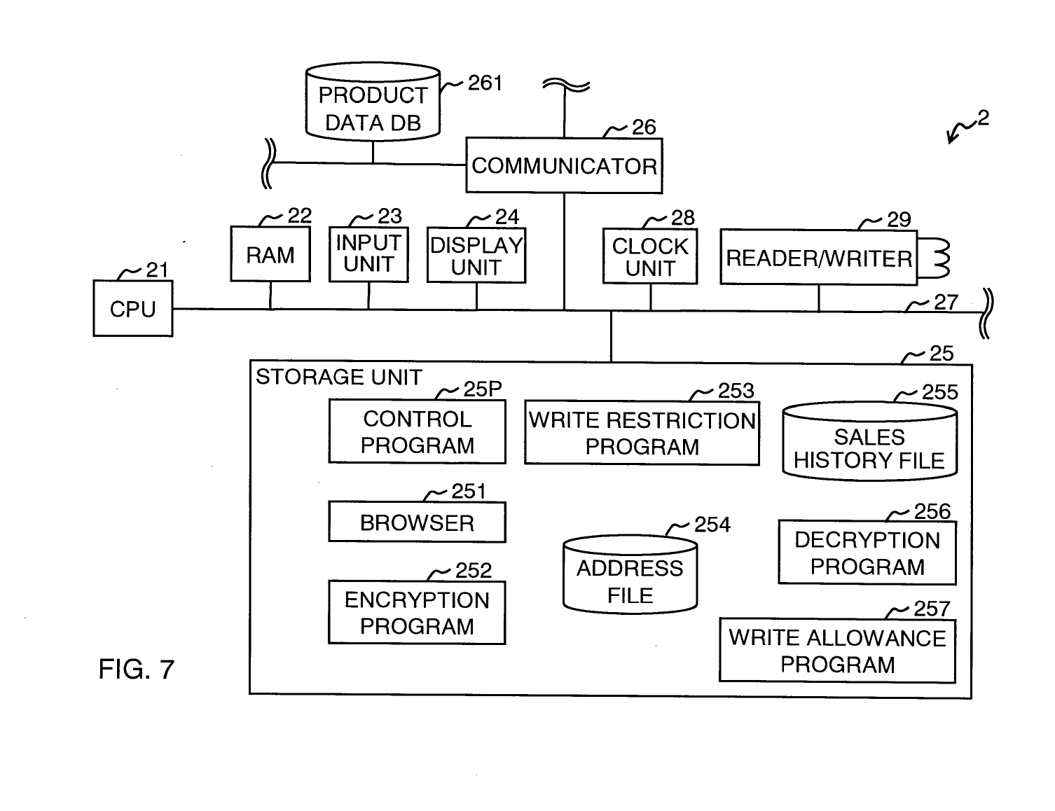

FIG. 7 is a block diagram illustrating a hardware configuration of the client 2 according to a first embodiment of the present invention. The client 2 includes a CPU 21 as a controller, a RAM 22, an input unit 23, a display unit 24, a clock unit 28, a communicator 26, a product data DB 261, the reader/writer 29, a bus 27, and a storage unit 25. The storage unit 25 stores a control program 25P, a browser 251, an encryption program 252, a write restriction program 253, an address file 254, a sales history file 255, a decryption program 256, and a write allowance program 257. The configuration of the client 2 is similar to that of the client 1 and thus, its detailed description is omitted.

The client 2 operated by a carrier is positioned downstream of the client 1 operated by the beer producer and positioned upstream of the client 3. Therefore, the client 2 can buy product data and excess area from the client 1 and in addition, can sell to the client 3 product data (for example, delivery history and a driver's name) stored in the product data DB 261 connected to the client 2 or a part of the bought excess area as an area for sale.

The CPU 21 reads encrypted product data stored in a product data section 653 of the wireless tag 6 with the reader/writer 29. The CPU 21 starts the decryption program 256 and decrypts the encrypted product data with a decryption key sent from the web server 5. Thus, the product data bought from the client 1 can be used. The CPU 21 starts the write allowance program 257 and outputs to the reader/writer 29 a write password sent from the web server 5.

The communicator 66 of the wireless tag 6 receives the sent write password. The controller 61 determines whether the received write password matches with the write password stored in the memory 62. If matched, the controller 61 reads addresses stored in the memory 62 and cancels the write restriction to the addresses. As a result, the carrier can freely use the area which the write restriction thereto has been canceled and can sell product data and excess area using this area. In FIG. 3, the decryption program and the write allowance program are omitted from the storage unit 15 of the client 1 for ease of description but can be, of course, stored.

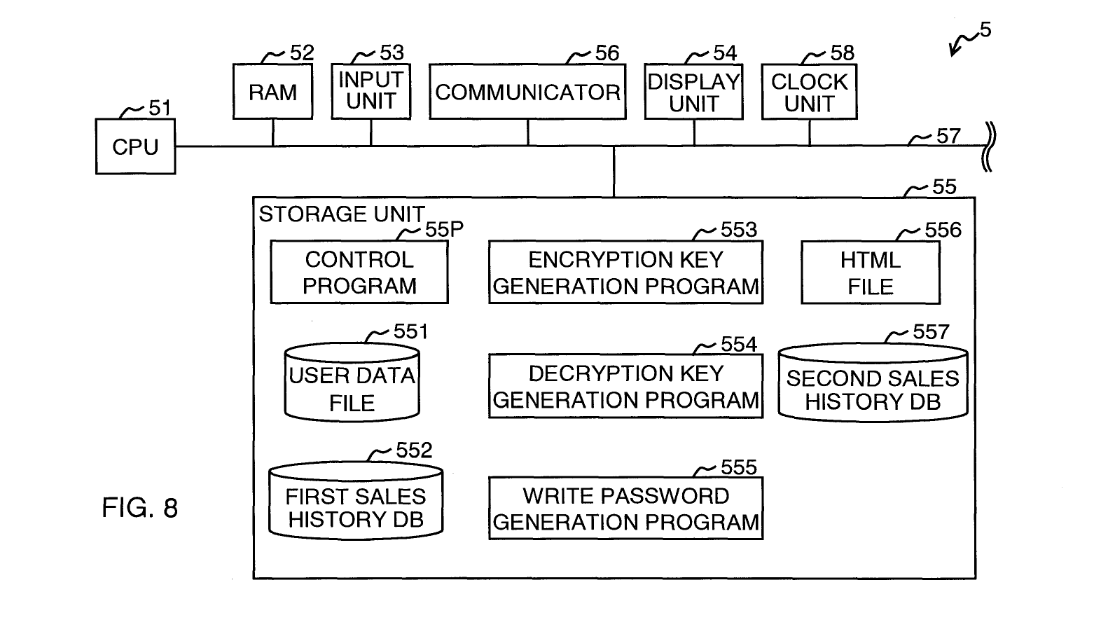

FIG. 8 is a block diagram illustrating a hardware configuration of the web server 5 according to a first embodiment of the present invention. The web server 5 includes a CPU 51 as a controller, a RAM 52, an input unit 53, a display unit 54, a clock unit 58, a communicator 56, and a storage unit 55. The CPU 51 is connected to hardware components of the web server 5 via a bus 57 and controls the hardware components. The CPU 51 also performs software functions in accordance with a control program 55P, an encryption key generation program 553, a decryption key generation program 554, and a write password generation program 555 stored in the storage unit 55.

The display unit 54 is, for example, a liquid crystal display. The input unit 53 includes a keyboard and a mouse. The communicator 56 is, for example, a gateway that serves as a firewall. The clock unit 58 outputs data of current date and time to the CPU 51. The storage unit 55 is, for example, a hard disk storing the control program 55P, a user data file 551, a first sales history DB 552, a second sales history DB 557, and an HTML (hyper text markup language) file 556.

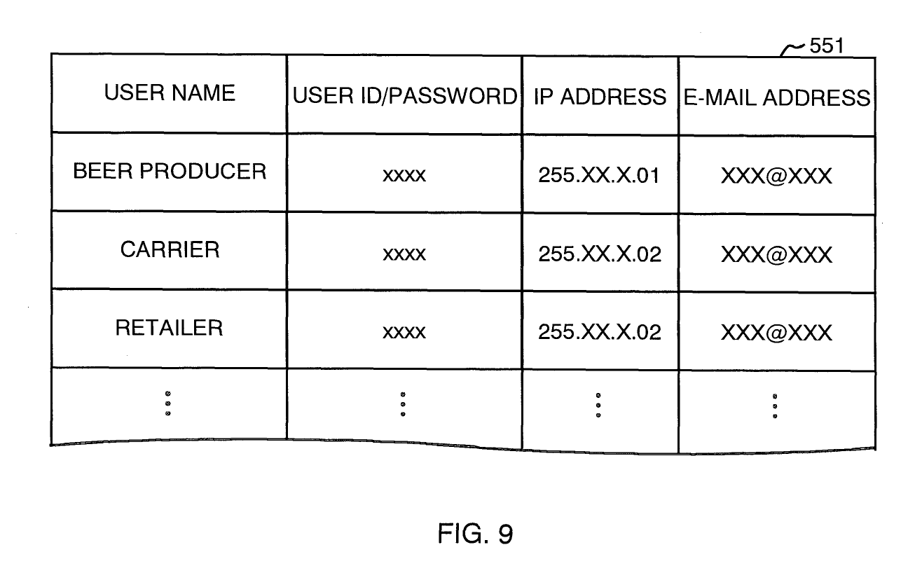

FIG. 9 is a diagram illustrating a record layout of the user data file 551 according to a first embodiment of the present invention. A record of the user data file 551 stores an IP (Internet protocol) address of a user in association with a user name. The record of the user data file 551 includes a “user name” field, a “user ID/password” field, an “IP address” field, and an “e-mail address” field. The “user name” field stores a name for identifying each user. In this example, data about the beer producer using the client 1, the carrier using the client 2, and the retailer using the client 3 are stored therein.

The “user ID/password” field stores a user ID and password necessary to log in a system of the web server 5 in association with a user name. The “IP address” field stores each IP address of the clients 1 to 3 in association with a user name. Further, the “e-mail address” field stores an e-mail address of each user. When the client 1 accesses the web server 5, the CPU 51 reads from the HTML file 556 screen data of screen image for registering user data and sends the screen data to the client 1 via the communicator 56.

The CPU 11 of the client 1 displays screen image on the browser 151 on the basis of the received screen data. A user inputs via input unit 13 initial registration data including a user name, a user ID, a password, an IP address, an e-mail address, a payment option, a telephone number, and a residence address. The CPU 11 accepts the input data and sends the input data to the web server 5. The CPU 51 of the web server 5 receives the data and stores in the user data file 551.

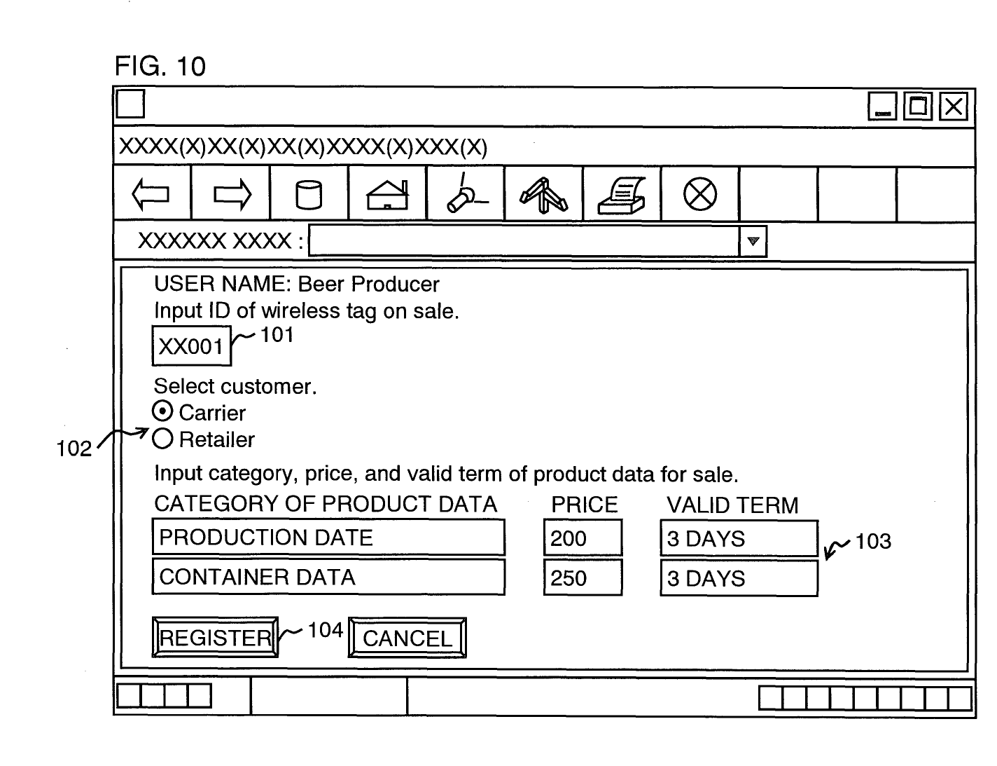

FIG. 10 is a diagram illustrating a screen image for a registration of product data for sale according to a first embodiment of the present invention. After the log-in of the client 1, the CPU 51 of the web server 5 reads from the HTML file 556 screen data of screen image for registration of the product data shown in FIG. 10 and sends the screen data to the client 1. The CPU 11 of the client 1 displays screen image for the product data registration screen on the browser 151. The product data registration screen includes an ID input box 101 for inputting an ID of a wireless tag 6 on sale, a selection box 102 for choosing a customer, a detailed data input box 103 for inputting a product data category, price, and valid term, and a register button 104.

Template data for the product data registration screen is stored in the HTML file 556 in advance. The CPU 51 of the web server 5 reads the template data from the HTML file 556 in response to a request from the log-in user, and writes user names (in this example, a carrier and a retailer) other than the log-in user, stored in the user data file 551, adjacent to the selection box 102 to generate screen data of registration screen for a product data to be sent.

The beer producer inputs an ID of a wireless tag 6 on sale to the ID input box 101 via the input unit 13 of the client 1, and in addition, clicks on a white circle in the selection box 102 to select a customer name via the input unit 13. In this example, the beer producer selects a carrier as a customer. Further, the beer producer inputs a category, price, and valid term of product data for sale in the detailed data input box 103 via the input unit 13. The price is input in association with the product data category. The beer producer inputs an appropriate price as a return for an access to read these product data categories from the carrier or retailer positioned downstream of the producer. After the completion of inputting data via the input unit 13, the user clicks the register button 104. In this example, XX001 is set as an ID, and a carrier and a retailer are set as customers. Further, a production date is input as a product data category, with a price (200 yen), and a valid term (3 days). The valid term corresponds to a period of time between the date when the user clicks the register button 104 to start selling and the date of sales termination.

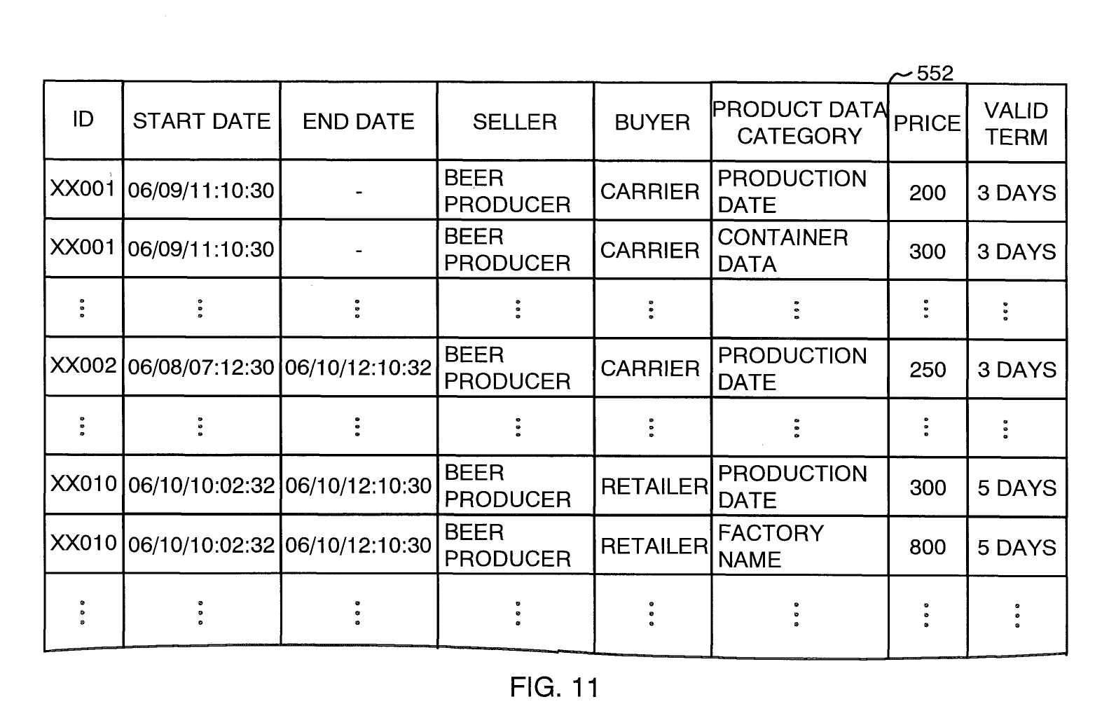

The CPU 11 sends the ID, customer name, and product data category, price, and valid term input via the input unit 13 to the web server 5 in response to the click on the register button 104. The CPU 51 of the web server 5 stores these data in the first sales history DB 552. FIG. 11 is a diagram illustrating a record layout of the first sales history DB 552 according to a first embodiment of the present invention. A record of the first sales history DB 552 includes an “ID” field, a “start date” field, an “end date” field, a “seller” field, a “buyer” field, a “product data category” field, a “price” field, and a “valid term” field.

The “ID” field stores an ID of a wireless tag 6 on sale sent from the client 1. The “start date” field stores a date and time when product data for sale was received from the client 1. The CPU 51 acquires the date and time with reference to output data from the clock unit 58 and stores the acquired data in the “start date” field in association with the ID. In the following description, the year is not described for ease of explanation. The “end date” field stores a date and time when the selling is completed. In this example, the selling of product data stored in a wireless tag 6 having an ID of XX001 has not been completed, so no data is stored in the “end date” field. On the other hand, product data stored in a wireless tag 6 having an ID of XX002 has been already sold on June 10, 12:10:32. Data of this date and time is stored in the “end date” field.

The “seller” field stores a name of a user who sells product data. The “buyer” field stores a name of a user who buys product data. For example, as for a wireless tag 6 having an ID of XX001, “beer producer” is stored in the “seller” field, and “carrier” is stored in the “buyer” field. The “product data category” field stores a category of product data for sale. For example, as for a wireless tag 6 having an ID of XX001, “production date” and “container data” are stored as product data for sale. The “price” field stores an asking price of the seller. The “valid term” field stores a valid term. The above settings of various databases and file data can be changed in accordance with design as appropriate. In this way, each time data such as a category of product data for sale is sent from the client 1, the CPU 51 stores the data in the first sales history DB 552. When the selling is completed, the CPU 51 acquires the date and time with reference to output data of the clock unit 58 and stores the acquired data in the “end date” field in association with the ID.

On receiving data of an ID, customer name, product data category, price, and valid term from the client 1, the CPU 51 extracts data of the customer name. Then, the CPU 51 reads an e-mail address from the user data file 551 on the basis of the extracted data of the customer name. In this example, an e-mail address of a carrier is read. The CPU 51 starts a mailer stored in the storage unit 55 and sends an e-mail for notification to the read e-mail address. For example, the e-mail includes a message such as “a beer producer starts selling product data to a carrier” and a hyperlink for accessing the web server 5. The CPU 51 writes the customer name (in this example, carrier) in the template data read from the storage unit 55, and reads a seller name (in this example, beer producer) from the user data file 551 with reference to an IP address or the like and writes the seller name in the template data. As a result, a user positioned at a downstream site may know the start of the sale in real time.

Next, how the client 2 of the carrier accesses the web server 5 to buy product data will be discussed. The CPU 21 of the client 2 sends to the web server 5 the user ID, password, and IP address input via the input unit 23. The CPU 51 of the web server 5 references the user data file 551 on the basis of the received user ID and password to perform authentication. The CPU 51 reads a corresponding user name. The CPU 51 searches the first sales history DB 552 on the basis of the read user name, and reads a record with the read user name in the “buyer” field and no data in the “end date” field.

In this example, the CPU 51 reads “production date” as the product data category with an ID “XX001”, price “200” yen, start date, and valid term “3 days” from a record with “carrier” in the “buyer” field and no data in the “end date” field. Further, the CPU 51 reads “container data” as the product data category with an ID “XX001”, price “300 yen”, start date, and valid term “3 days” from another record with “carrier” in the “buyer” field and no data in the “end date” field. The CPU 51 adds the valid term to the start date to determine a deadline. In this example, the deadline is determined as “3 days later”, June 12, 11:10:30.

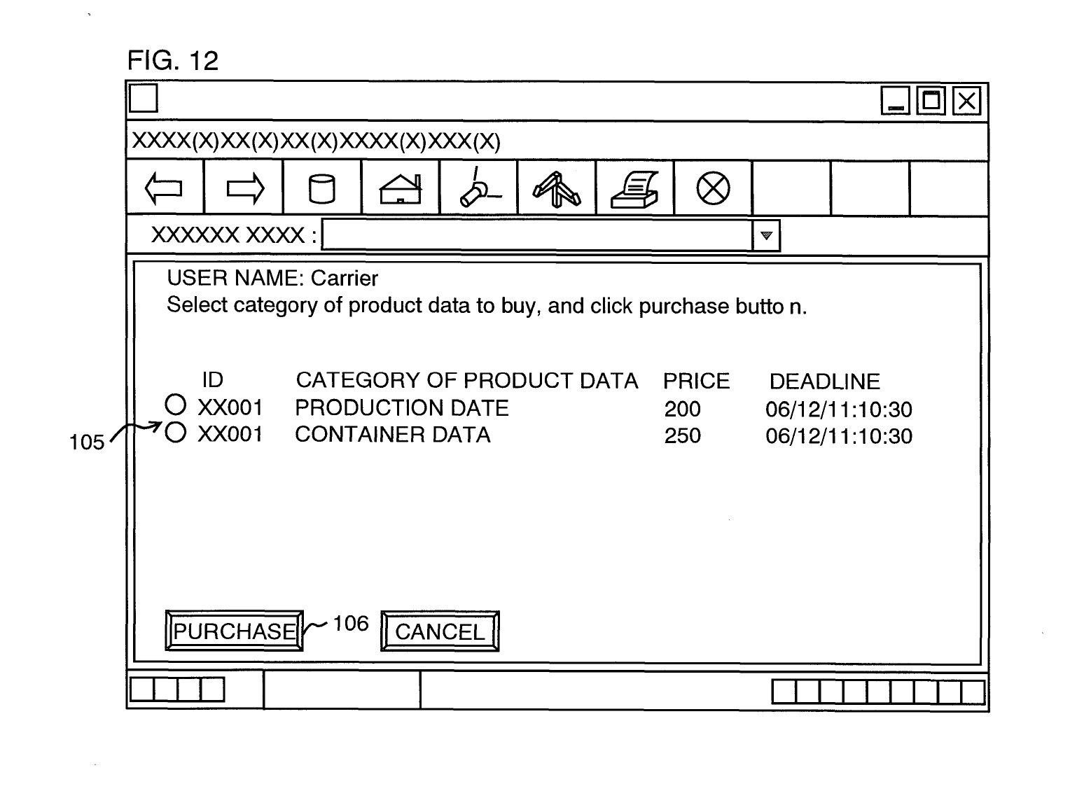

The CPU 51 writes the read data (ID, product data category, and price) and deadline in the template data read from the HTML file 556 to make a screen data, and sends the screen data to the client 2. FIG. 12 is a diagram illustrating a screen image for a purchase of product data according to a first embodiment of the present invention. An ID of a wireless tag 6 on sale, product data category, price, and deadline are displayed on the browser 251 as shown in FIG. 12. As shown in FIG. 12, it is displayed that a production date is on sale at a price of 200 yen as a category of product data to be stored in a memory unit 65 of a wireless tag 6 having an ID “XX001”. Further, the deadline of the sale is June 12, 11:10:30.

Likewise, it is displayed that container data is on sale at a price of 250 yen as a category of product data to be stored in the memory unit 65 of the wireless tag 6 having then ID “XX001”. The deadline of the sale is also June 12, 11:10:30. On the left of each item of the production date and container data, a selection box 105 for selecting the item is displayed. The user clicks a white circle of the selection box 105 via the input unit 23 and operates a purchase button 106 to buy the product data. On accepting the operation on the purchase button 106 as well as the product data category selected via the input unit 23, the CPU 21 sends a purchase command and the accepted product data category and ID to the web server 5 as data representing a purchase.

The CPU 51 of the web server 5 receives the purchase command, ID, and product data category sent from the client 2. The CPU 51 acquires the date and time with reference to output data from the clock unit 58 and stores the acquired data in the “end date” field of the corresponding record stored in the first sales history DB 552. As a result, a sales contract of the product data to be written to the memory unit 65 of the wireless tag 6 is made between the clients 1 and 2.

Next, the encryption key generation process will be discussed. On storing the end date in the first sales history DB 552, the CPU 51 starts the encryption key generation program 553 to generate an encryption key. Likewise, the CPU 51 starts the decryption key generation program 554 to generate a decryption key that can decrypt data encrypted with the generated encryption key. The CPU 51 references the first sales history DB 552 to read data about the seller and the buyer. Then, the CPU 51 references the user data file 551 to read an e-mail address corresponding to each of the seller and the buyer. The CPU 51 sends the encryption key to the e-mail address of the seller (in this example, beer producer) and sends the decryption key to the e-mail address of the buyer (in this example, carrier).

Thus, the sold product data can be encrypted with the encryption key at the client 1 side. Further, the encrypted data of the bought product data can be decrypted with the decryption key and utilized at the client 2 side. This embodiment discusses the case where the encryption key and decryption key are sent via an e-mail, but the encryption key and decryption key may respectively sent on the client 1 or 2 accessing the web server 5. In this embodiment, the encryption key and decryption key are generated in the web server 5, but the present invention is not restricted thereto. For example, the encryption key and decryption key may be generated in an authentication server computer (not shown) of an independent organization such as VeriSign. In this case, the CPU 51 of the web server 5 sends to the authentication server computer an e-mail address of the seller and data requesting generation of an encryption key. Further, the CPU 51 of the web server 5 sends to the authentication server computer an e-mail address of the buyer and data requesting generation of a decryption key. The authentication server computer then generates an encryption key and a corresponding decryption key and sends each of the keys to the corresponding e-mail address.

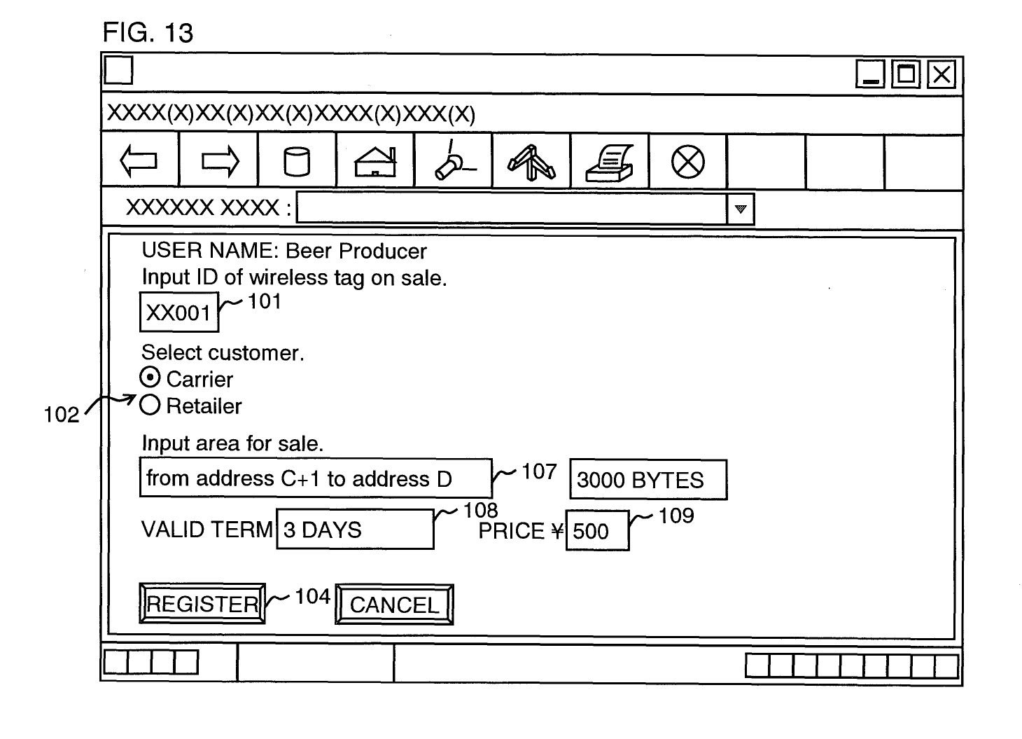

Next, how to sell and buy an area for sale in the memory unit 65 of the wireless tag 6 will be discussed. The CPU 51 of the web server 5 reads from the HTML file 556 screen data of registration screen for the area for sale and sends the screen data to the client 1 via the communicator 56. The CPU 11 of the client 1 displays screen image for the registration screen on the browser 151. FIG. 13 is a diagram illustrating a screen image for a registration of an area for sale according to a first embodiment of the present invention. The registration screen includes an ID input box 101 for inputting an ID of a wireless tag 6 on sale, a selection box 102 for selecting a customer, an area input box 107 for inputting addresses of an area for sale, a valid term input box 108, a price input box 109, and a register button 104.

The beer producer inputs an ID of the wireless tag 6 on sale to the ID input box 101. Further, the beer producer selects a customer via the selection box 102. The beer producer inputs addresses of an area for sale within excess area of the memory unit 65 of the wireless tag 6 to the area input box 107. In this example, an area from the address C+1 to the address D is input. When the area for sale is input to the area input box 107, the browser 151 starts a program sent from the web server 5 to calculate a data size of the area. The program multiplies a data size corresponding to an address by the number of addresses input to the area input box 107 to calculate the total data size. In this example, the calculation result is 3000 bytes, which is displayed on the browser.

The beer producer inputs via the input unit 13 a valid term to the valid term input box 108 and a price of the area for sale to the price input box 109. In this example, the valid term is set to 3 days, and the price is set to 500 yen. As for the price, the beer producer positioned at an upstream site inputs an asking price in return for writing access to the area for sale in the memory unit 65 by a carrier or retailer positioned at a downstream site. The CPU 11 of the client 1 accepts data of the ID, customer, area for sale, valid term, and price input via the input unit 13. The CPU 11 sends the input data of the ID, customer, valid term, price, and area for sale to the web server 5 in response to the click on the register button 104.

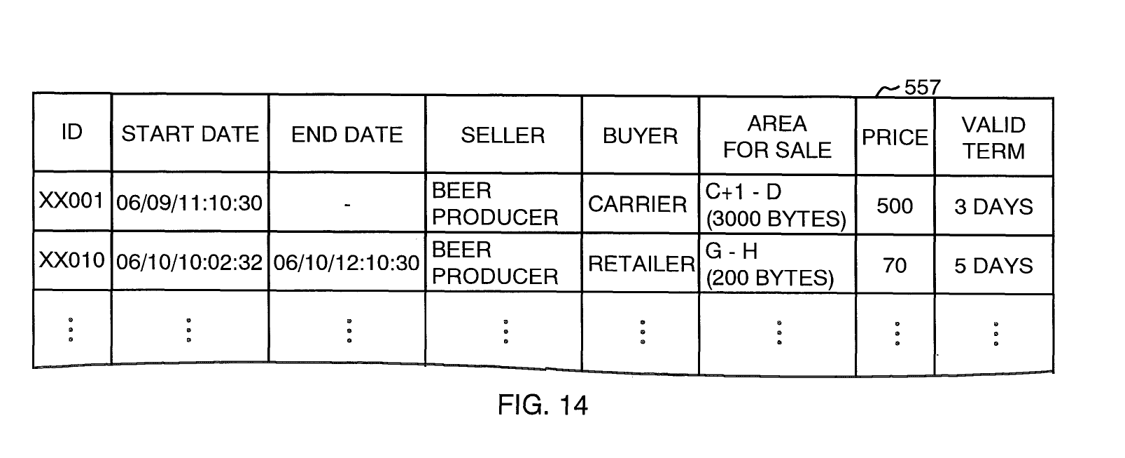

The CPU 51 of the web server 5 receives the data of the ID, customer, valid term, price, and area for sale sent from the client 1 and stores the received data in the second sales history DB 557. FIG. 14 is a diagram illustrating a record layout of the second sales history DB 557 according to a first embodiment of the present invention. A record of the second sales history DB 557 includes an “ID” field, a “start date” field, an “end date” field, a “seller” field, a “buyer” field, an “area for sale” field, a “price” field, and a “valid term” field.

The fields other than the “area for sale” field are similar to those of the first sales history DB 552 shown in FIG. 11. Thus, detailed description of these fields is omitted. The “area for sale” field stores data of an area for sale sent from the client 1 in association with an ID. In this example, addresses for 3000 bytes of memory area from C+1 to D are stored. On receiving the ID, customer name, area for sale, price, and valid term from the client 1, the CPU 51 extracts the customer name. Then, the CPU 51 reads an e-mail address from the user data file 551 on the basis of the extracted customer name. In this example, an e-mail address of the carrier is read. The CPU 51 starts the mailer stored in the storage unit 55 and sends an e-mail for notification to the read e-mail address. For example, the e-mail includes a message such as “a beer producer starts selling memory area of a wireless tag to a carrier” and a hyperlink for accessing the web server 5.

The CPU 51 writes the customer name (in this example, carrier) in the template data read from the storage unit 55, and reads a seller name (in this example, beer producer) from the user data file 551 with reference to an IP address or the like and writes the seller name in the template data. As a result, a user positioned at a downstream site may know the start of the sale in real time.

Next, how the client 2 of the carrier accesses the web server 5 to buy an area for sale will be discussed. The CPU 21 of the client 2 sends to the web server 5 the user ID, password, and IP address input via the input unit 23. The CPU 51 of the web server 5 references the user data file 551 on the basis of the received user ID and password to perform authentication. The CPU 51 reads a corresponding user name. The CPU 51 searches the second sales history DB 557 on the basis of the read user name, and reads a record with the read user name in the “buyer” field and no data in the “end date” field.

The CPU 51 reads addresses “C+1−D (3000 bytes)” for an area for sale with an ID “XX001”, price “500” yen, start date, and the valid term “3 days” from a record with “carrier” in the “buyer” field and no data in the “end date” field. The CPU 51 adds the valid term to the start date to determine a deadline. In this example, the deadline is determined as “3 days later”, June 12, 11:10:30.

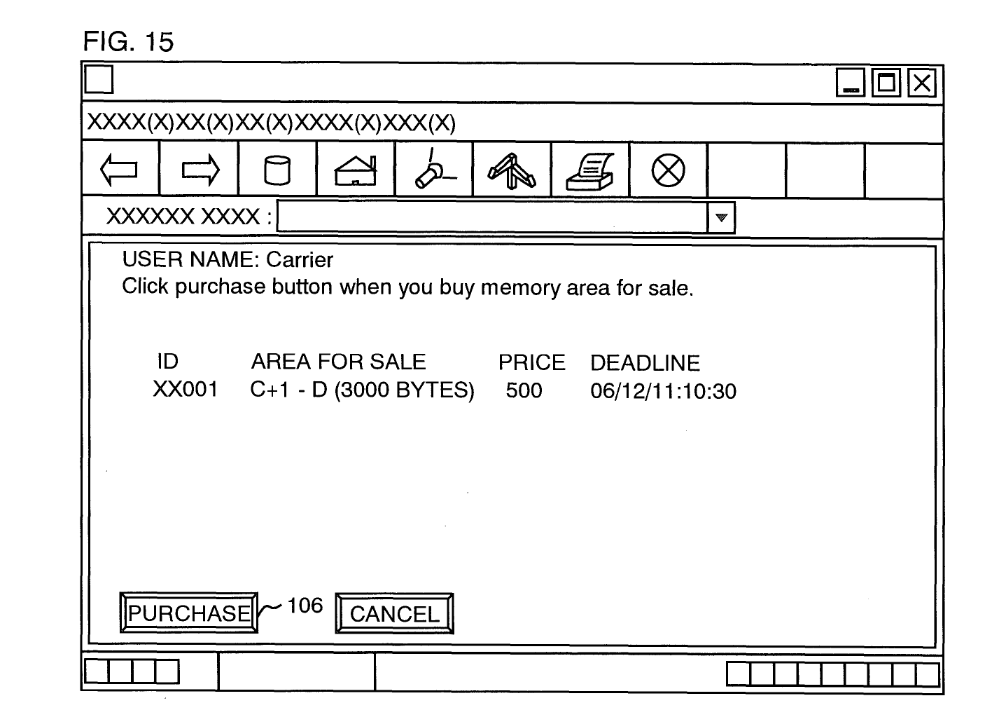

The CPU 51 writes the read data (ID, area for sale, and price) and deadline in the template data read from the HTML file 556 to make screen data, and sends the screen data to the client 2. FIG. 15 is a diagram illustrating a screen image for a purchase of an area for sale according to a first embodiment of the present invention. An ID of a wireless tag 6 on sale, area for sale, price, and deadline are displayed on the browser 251 as shown in FIG. 15. As shown in FIG. 15, it is displayed that a memory area from address C+1 to address D (3000 bytes) is on sale at a price of 500 yen as an area for sale in a memory unit 65 of a wireless tag 6 having an ID “XX001”. Further, the deadline of the sale is June 12, 11:10:30.

The user operates the purchase button 106 to buy the area for sale. On accepting the operation on the purchase button 106 via the input unit 23, the CPU 21 sends a purchase command and the area for sale and ID to the web server 5 as data representing a purchase.

The CPU 51 of the web server 5 receives the purchase command, ID, and area for sale sent from the client 2. The CPU 51 acquires the date and time with reference to output data from the clock unit 58 and stores the acquired data in the “end date” field of the corresponding record stored in the second sales history DB 557. As a result, a sales contract of the area for sale in the memory unit 65 of the wireless tag 6 is made between the clients 1 and 2.

Next, the write password generation process will be discussed. On storing the end date in the second sales history DB 557, the CPU 51 starts the write password generation program 555 to generate a write password. The CPU 51 references the second sales history DB 557 to read data about the seller and the buyer. Then, the CPU 51 references the user data file 551 to read an e-mail address corresponding to each of the seller and the buyer. The CPU 51 sends the write password, ID, and area for sale to the e-mail address of the seller (in this example, beer producer) and also sends the write password, ID, and area for sale to the e-mail address of the buyer (in this example, carrier).

Thus, the sold area for sale can be protected with the write password from a write access at the client 1 side. Further, the bought area for sale can be utilized by canceling, with the write password, the restriction on the write access at the client 2 side.

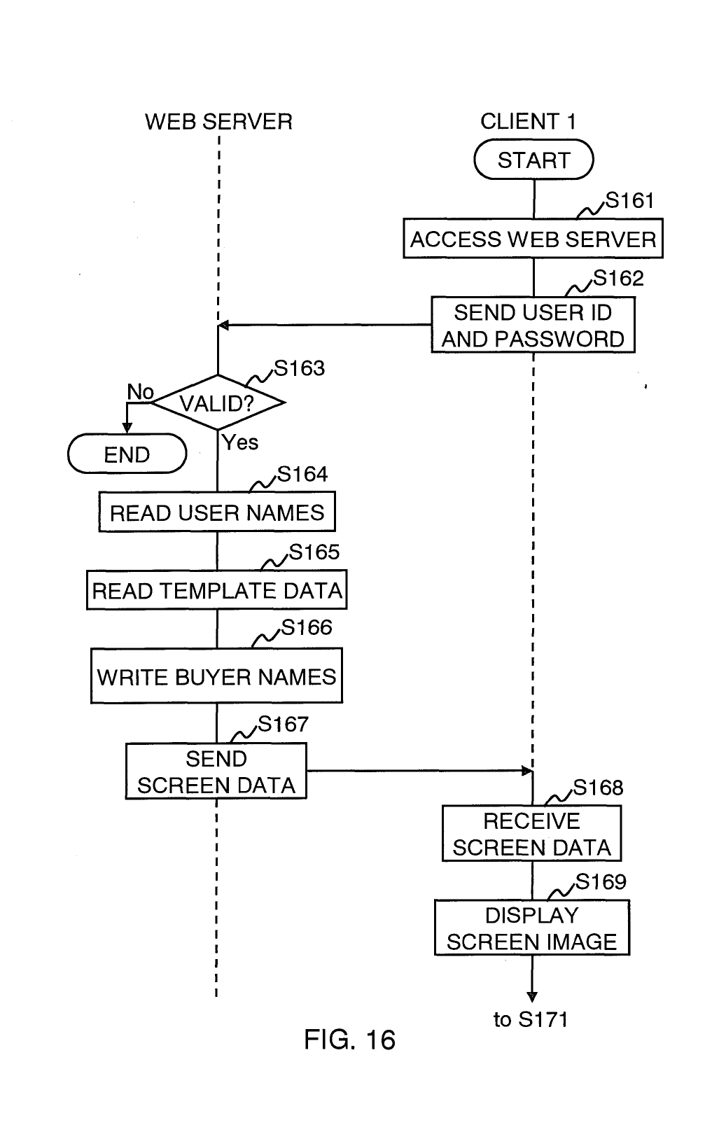

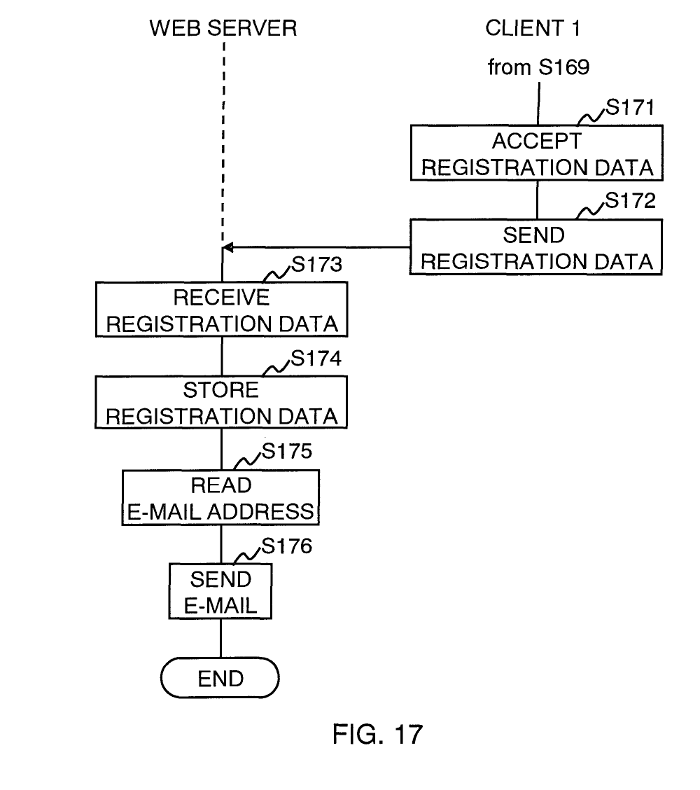

The software processing based on the above discussed hardware configuration according to the first embodiment of the present invention will be discussed with reference to flowcharts. FIGS. 16 and 17 are diagrams illustrating a flowchart of a registration process of product data for sale according to a first embodiment of the present invention. The CPU 11 of the client 1 starts the browser 151 to access the web server 5 (operation S161). The CPU 11 accepts a user ID and password input via the input unit 13 and sends the input data to the web server 5 (operation S162). The CPU 51 of the web server 5 receives and authenticates the user ID and password with reference to the user data file 551 (operation S163).

If the received user ID and password are invalid (No in operation S163), in other words, if the received user ID and password do not match with a user ID and password stored in the user data file 551, the CPU 51 terminates the process because of an unauthenticated access. On the other hand, if the received user ID and password are valid (Yes in operation S163), in other words, if the received user ID and password match with a user ID and password stored in the user data file 551, the CPU 51 reads a user name corresponding to the user ID and other buyer names from the user data file 551 (operation S164). In this example, a beer producer is read as the user name corresponding to the user ID, and a carrier and a retailer are read as the other buyer names.

The CPU 51 reads template data for a product data registration screen from the HTML file 556 (operation S165). The CPU 51 writes the user name and the buyer names, which are read in operation S164, to the read template data (operation S166) and sends the resultant screen data of the product data registration screen to the client 1 (operation S167). To be specific, the buyer names are written adjacent to the selection box 102 so as to select a buyer name. The CPU 11 of the client 1 receives the screen data of the product data registration screen (operation S168) and displays screen image for the product data registration screen on the browser 151 as shown in FIG. 10 (operation S169).

The CPU 11 accepts registration data including an ID of a wireless tag 6, a selected user, and a product data category, price, and valid term input via the input unit 13 (operation S171), and sends the registration data including the ID, the selected user, and the product data category, price, and valid term to the web server 5 (operation S172). The CPU 51 of the web server 5 receives the registration data including the ID, the selected user, and the product data category, price, and valid term via the communicator 56 (operation S173) and stores the registration data in the first sales history DB 552 (operation S174). The CPU 51 reads an e-mail address of the selected user from the user data file 551 (operation S175). The CPU 51 starts a mailer stored in the storage unit 55 and sends, to the e-mail address read in operation S175, an e-mail informing that the product data category is on sale (operation S176).

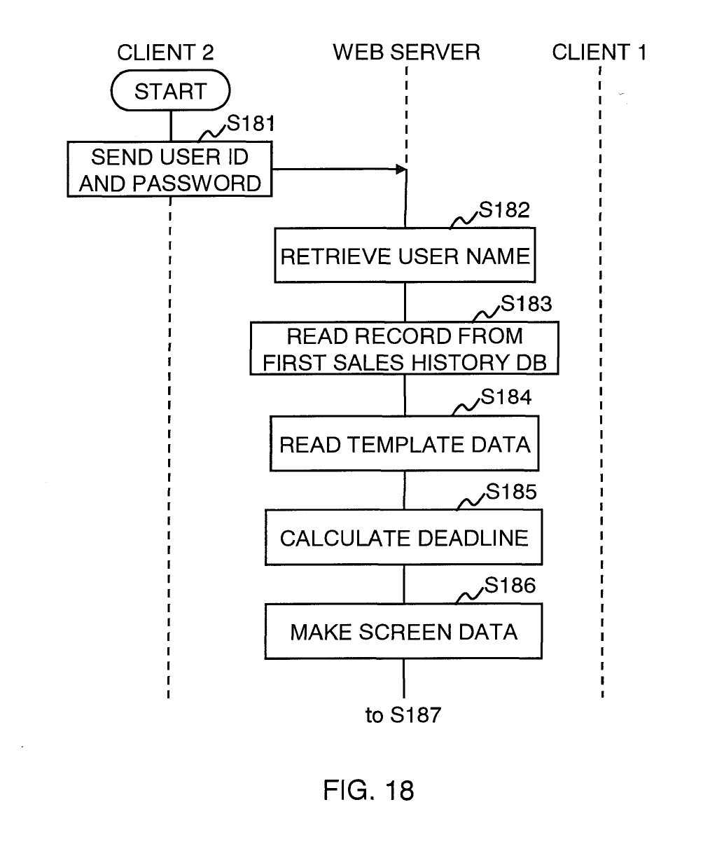

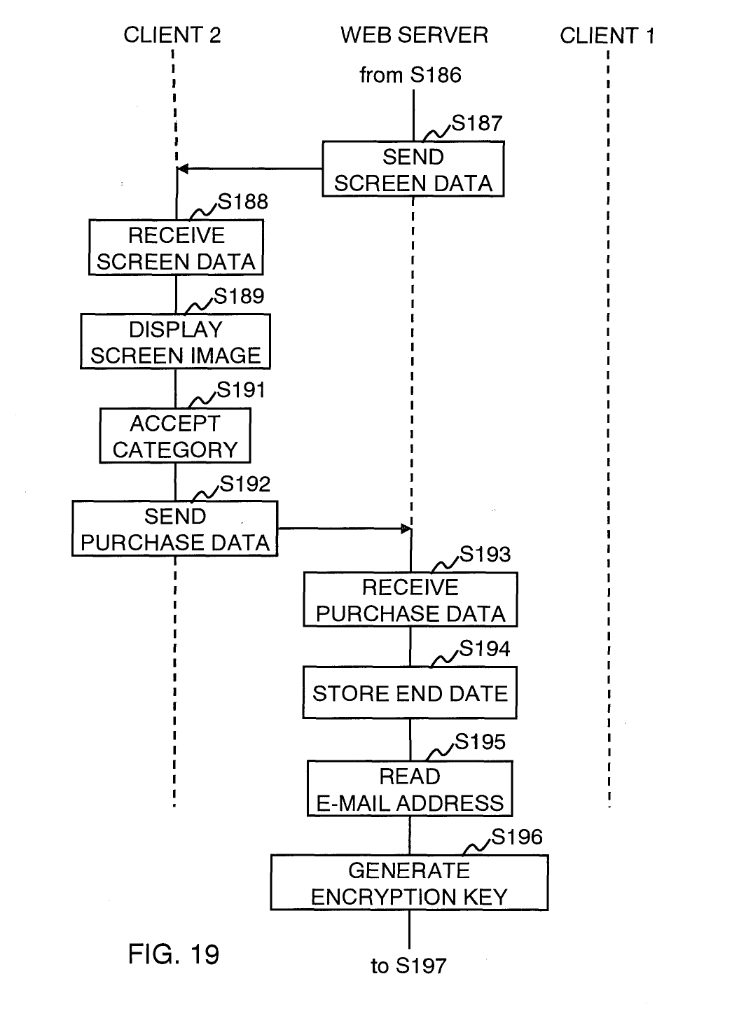

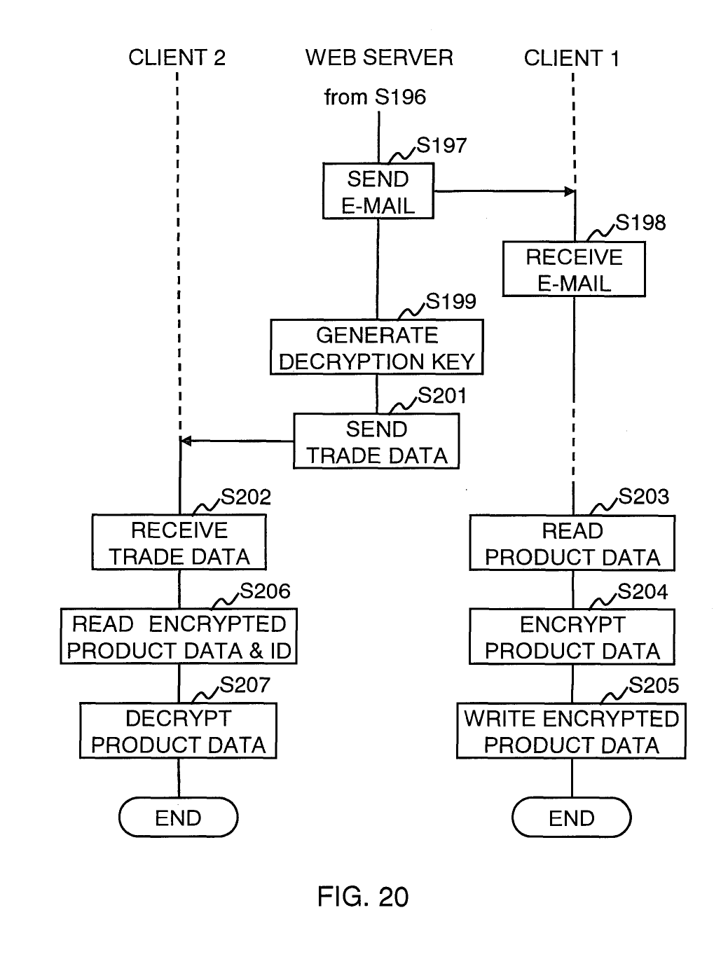

FIGS. 18 to 20 are diagrams illustrating a flowchart of an encryption and decryption process according to a first embodiment of the present invention. The CPU 21 of the client 2 accepts a user ID and password input via the input unit 23 and sends the input data to the web server 5 (operation S181). The CPU 51 of the web server 5 authenticates the received user ID and password. When verified, the CPU 51 extracts a user name corresponding to the user ID from the user data file 551 (operation S182). The CPU 51 reads a record of the first sales history DB 552 having the user name extracted in operation S182 in the “buyer” field and no data in the “end date” field (operation S183).

The CPU 51 reads template data for a product data purchase screen from the HTML file 556 (operation S184). The CPU 51 adds the valid term to the start date in the record read in operation S183 to determine the deadline (operation S185). The CPU 51 writes the ID, product data category, and price in the record read in operation S183, and the deadline determined in operation S185 to the template data read in operation S184 to make screen data (operation S186).

The CPU 51 sends to the client 2 the screen data of the product data purchase screen including the above described data (operation S187). The CPU 21 of the client 2 receives the screen data of the product data purchase screen (operation S188), and displays screen image for the product data purchase screen on the browser 251 as shown in FIG. 12 (operation S189). The CPU 21 accepts the product data category input via the input unit 23 (operation S191). On accepting the operation on the purchase button 106 shown in FIG. 12 via the input unit 23, the CPU 21 sends purchase data including a purchase command, an ID, and the product data category to the web server 5 (operation S192).

The CPU 51 of the web server 5 receives the purchase data including the purchase command, the ID, and the product data category (operation S193). The CPU 51 acquires the date and time with reference to output data from the clock unit 58 and stores the acquired data in the “end date” field of the corresponding record stored in the first sales history DB 552 (operation S194). The CPU 51 reads an e-mail address corresponding to the seller stored in the first sales history DB 552 with reference to the user data file 551 (operation S195).

The CPU 51 starts the encryption key generation program 553 to generate an encryption key (operation S196), and sends to the e-mail address of the seller, an e-mail including a message to the effect that a sales contract is made, which is read from the storage unit 55, the generated encryption key, and corresponding ID and product data category stored in the first sales history DB 552 (operation S197). The CPU 11 of the client 1 receives the e-mail including the message to the effect that a sales contract is made, the encryption key, and the ID and product data category (operation S198).

In parallel with the encryption key generation process in operation S196, the CPU 51 starts the decryption key generation program 554 to generate a decryption key that can decrypt data encrypted with the encryption key generated in operation S196 (operation S199). The CPU 51 sends, to the client 2, trade data including a message to the effect that a sales contract is made, which is read from the storage unit 55, the generated decryption key, and corresponding ID and product data category stored in the first sales history DB 552 (operation S201). The CPU 21 of the client 2 receives the trade data including the message, the decryption key, and the ID and product data category (operation S202).

The CPU 11 of the client 1 operated by the beer producer reads product data corresponding to the product data category received in operation S198 from the product data DB 161 shown in FIG. 4 (operation S203). In this example, “Jun. 1, 2007” is read as production date as the product data category, and “glass bottle” is read as the container data as the product data category. The CPU 11 encrypts the product data including the read data and category with the received encryption key (operation S204). The CPU 11 outputs the encrypted product data to the reader/writer 19.

The reader/writer 19 writes the encrypted product data to the product data section 653 of the wireless tag 6 having the ID included in the e-mail received in operation S198 (operation S205). The wireless tag 6 storing the product data encrypted this way is attached to the beer 4 and transferred to the carrier.

The carrier receives the beer 4 attached with the wireless tag 6 storing the encrypted product data. The CPU 21 of the client 2 reads the encrypted product data and the ID from the wireless tag 6 with the reader/writer 29 (operation S206). If the read ID matches with the ID received in operation S202, the CPU 21 decrypts the encrypted product data with the decryption key received in operation S202 (operation S207). As a result, the carrier can obtain product data necessary for delivery business, such as the production date and container data. Therefore, on reading data of the wireless tag 6 with the reader/writer 29, the carrier does not need to request the client 1 to send the product data, which enables speedy physical distribution and reduces communication traffic.

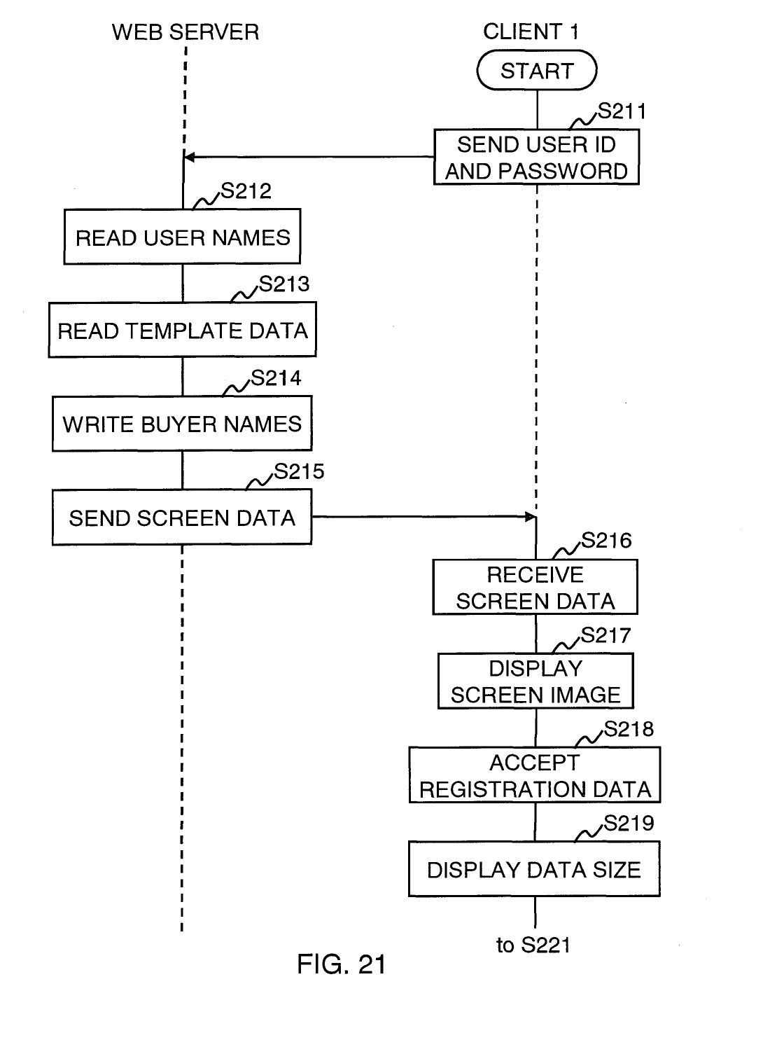

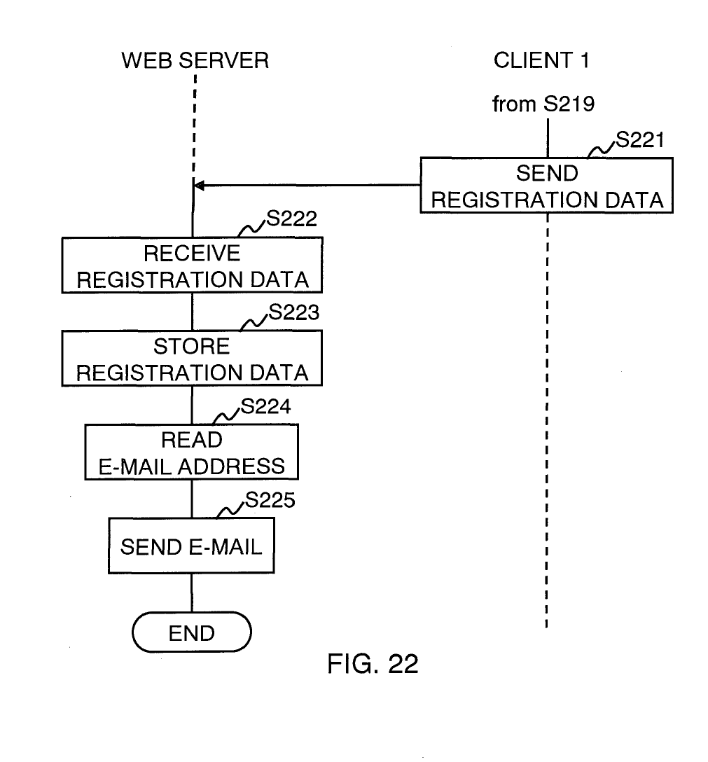

FIGS. 21 and 22 are diagrams illustrating a flowchart of a registration process of an area for sale according to a first embodiment of the present invention. The CPU 11 of the client 1 starts the browser 151 to access the web server 5. The CPU 11 accepts a user ID and password input via the input unit 13 and sends the input data to the web server 5 (operation S211). The CPU 51 of the web server 5 receives and authenticates the user ID and password with reference to the user data file 551. If the received user ID and password are verified, the CPU 51 reads a user name and buyer names from the user data file 551 (operation S212).

The CPU 51 reads template data for an area for sale registration screen from the HTML file 556 (operation S213). The CPU 51 writes the user name and the buyer names read in operation S212 to the read template data (operation S214), and sends the resultant screen data of area for sale registration screen to the client 1 (operation S215). The CPU 11 of the client 1 receives the screen data of the area for sale registration screen (operation S216) and displays screen image for the area for sale registration screen on the browser 151 as shown in FIG. 13 (operation S217).

The CPU 11 accepts registration data including an ID of a wireless tag 6, a selected user, and an area for sale, price, and valid term input via the input unit 13 (operation S218). The CPU 11 starts a program received with the screen data in operation S215 to calculate a data size of the area for sale received in operation S218 to display the calculated data size on the browser 151 (operation S219). The CPU 11 sends the registration data including the ID, the selected user, the area for sale, the calculated data size, and the price and valid term to the web server 5 (operation S221). The CPU 51 of the web server 5 receives the registration data including the ID, the selected user, the area for sale, the calculated data size, and the price and valid term via the communicator 56 (operation S222), and stores the registration data in the second sales history DB 557 (operation S223). The CPU 51 reads an e-mail address of the selected user from the user data file 551 (operation S224). The CPU 51 starts a mailer stored in the storage unit 55 and sends, to the e-mail address read in operation S224, an e-mail informing that the area for sale is on sale (operation S225).

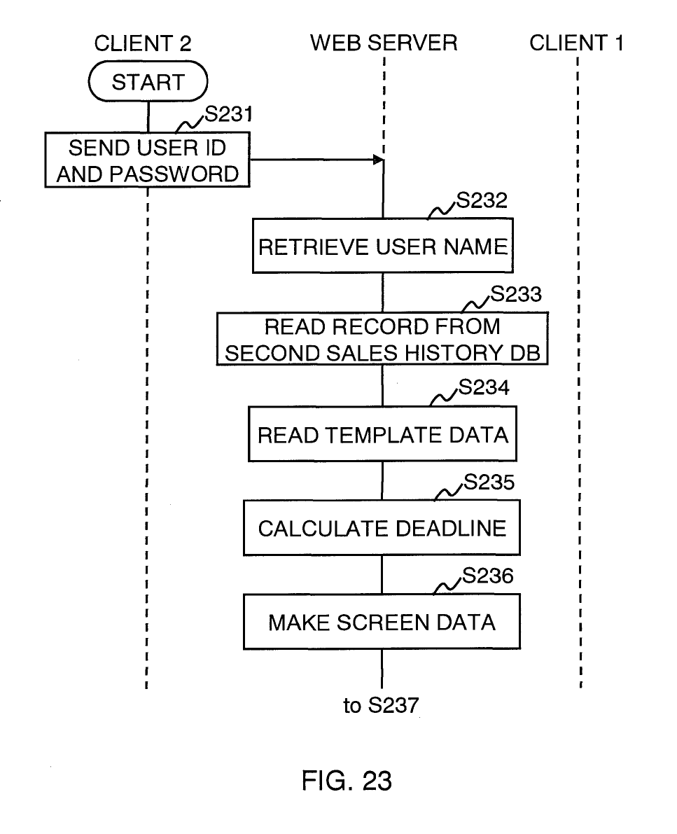

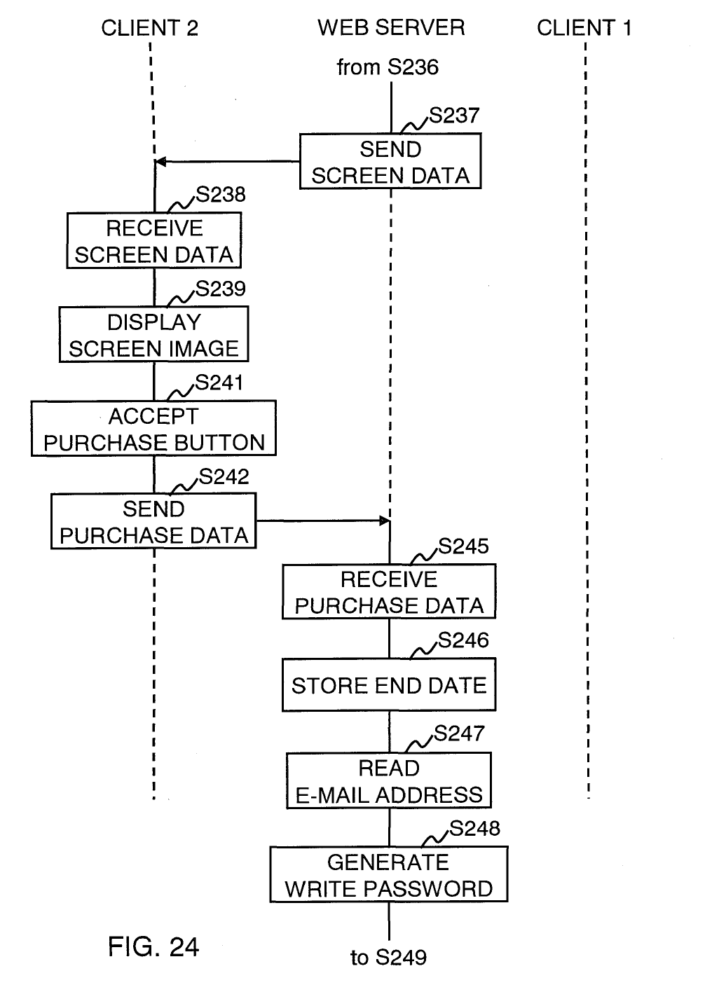

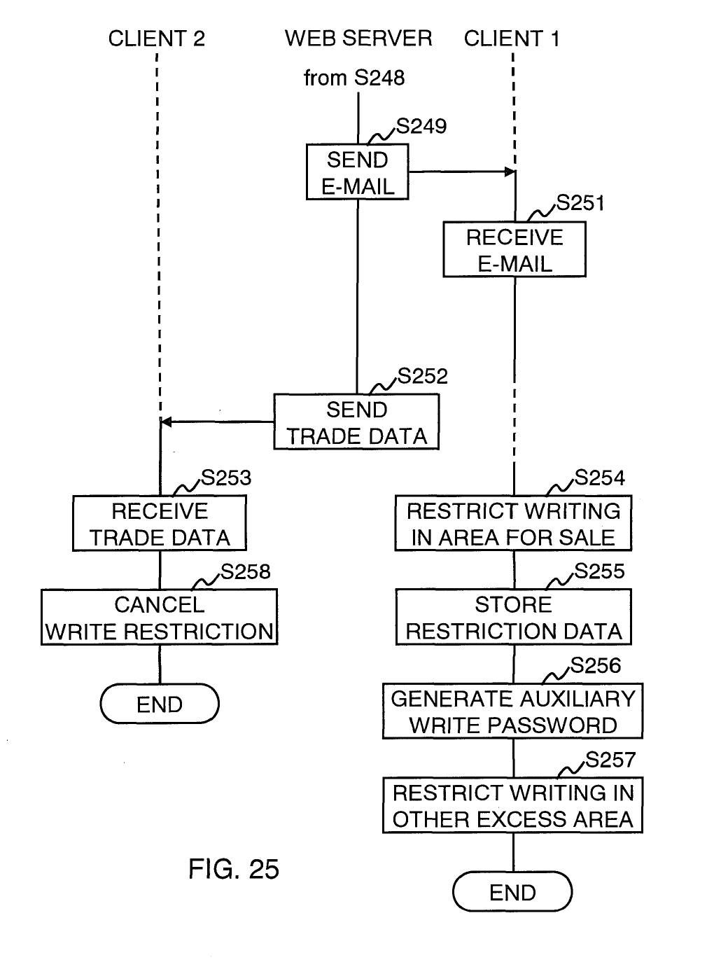

FIGS. 23 to 25 are diagrams illustrating a flowchart of a purchase process of an area for sale, a write restriction process, and a write allowance process according to a first embodiment of the present invention. The CPU 21 of the client 2 accepts a user ID and password input via the input unit 23 and sends the input data to the web server 5 (operation S231). The CPU 51 of the web server 5 authenticates the received user ID and password. When verified, the CPU 51 extracts a user name corresponding to the user ID from the user data file 551 (operation S232). The CPU 51 reads a record of the second sales history DB 557 shown in FIG. 14 having the user name extracted in operation S232 in the “buyer” field and no data in the “end date” field (operation S233).

The CPU 51 reads template data for an area for sale purchase screen from the HTML file 556 (operation S234). The CPU 51 adds the valid term to the start date in the record read in operation S233 to determine the deadline (operation S235). The CPU 51 writes the ID, area for sale, and price in the record read in operation S233, and the deadline determined in operation S235 to the template data read in operation S234 to make screen data (operation S236).

The CPU 51 sends to the client 2 the screen data of the area for sale purchase screen including the above described data (operation S237). The CPU 21 of the client 2 receives the screen data of the area for sale purchase screen (operation S238) and displays screen image for the area for sale purchase screen on the browser 251 as shown in FIG. 15 (operation S239). The CPU 21 accepts operation on the purchase button 106 via the input unit 23 (operation S241). On accepting the operation on the purchase button 106, the CPU 21 sends purchase data including a purchase command, an ID, and an area for sale to the web server 5 (operation S242).

The CPU 51 of the web server 5 receives the purchase data including the purchase command, the ID, and the area for sale (operation S245). The CPU 51 acquires the date and time with reference to output data from the clock unit 58 and stores the acquired data in the “end date” field of the corresponding record stored in the second sales history DB 557 (operation S246). The CPU 51 reads an e-mail address corresponding to the seller stored in the second sales history DB 557 with reference to the user data file 551 (operation S247).

The CPU 51 starts the write password generation program 555 to generate a write password (operation S248), and then sends to the e-mail address of the seller, an e-mail including a message to the effect that a sales contract is made, which is read from the storage unit 55, the generated write password, and corresponding ID and area for sale stored in the second sales history DB 557 (operation S249). The CPU 11 of the client 1 receives the e-mail including the message to the effect that a sales contract is made, the write password, and the ID and area for sale (operation S251).

The CPU 51 sends, to the client 2, trade data including a message to the effect that a sales contract is made, which is read from the storage unit 55, the generated write password, and corresponding ID and area for sale stored in the second sales history DB 557 (operation S252). The CPU 21 of the client 2 receives the trade data including the message, the write password, and the ID and area for sale (operation S253).

The CPU 11 of the client 1 operated by the beer producer restricts a write access to the area for sale in the wireless tag 6 having the ID corresponding to the received ID, with the write password included in the e-mail received in operation S251 (operation S254). The CPU 11 outputs the write password and the area for sale to the reader/writer 19. The reader/writer 19 restricts the write access to the area for sale in the memory unit 65 using the write password. The reader/writer 19 stores restriction data including address data of the area for sale and the write password in the memory 62 of the controller 61 (operation S255).

The CPU 11 starts an auxiliary write password generation program (not shown) stored in the storage unit 15 to generate an auxiliary write password (operation S256). The CPU 11 restricts a write access to whole excess area but the area for sale with the auxiliary write password via the reader/writer 19 (operation S257). The auxiliary write password is output to the controller 61 via the reader/writer 19, and the controller 61 stores the auxiliary write password in the memory 62. The wireless tag 6 including the area for sale in the memory unit 65 restricted to write this way is attached to the beer 4 and transferred to the carrier.

The carrier receivers the beer 4 attached with the access-restricted wireless tag 6. The CPU 21 of the client 2 cancels the restriction on the write access to the area for sale with the write password received in operation S253 (operation S258). To be specific, the write password is sent from the CPU 21 to the controller 61 via the reader/writer 29. The controller 61 determines whether the write password stored in the memory 62 matches with the received write password. If not matched, the write access is still restricted. If the controller 61 determines that these passwords are matched, an address of the area for sale is read from the memory 62 and the controller 61 cancels the write restriction to the area.

As a result, the carrier can freely use the purchased area for sale in the memory unit 65 of the wireless tag 6. On the other hand, a write access to excess area other than the area for sale is still restricted with the auxiliary write password. If the client 2 is positioned upstream of the client 3, the carrier can store its own product data in the area for sale and sell the data to a retailer. Further, the carrier can sell some of the purchased areas for sale to the client 3 by similar processing. Although the processing executed between the clients 1 and 2 is discussed in the first embodiment of the present invention, product data and areas for sale may be, of course, sold from the client 1 to both clients 2 and 3.

According to the first embodiment of the present invention, product data offered for sale is received and sent to the second terminal device by way of the central apparatus. When the product data is purchased, the product data is encrypted, which is the incentive that makes a user of the first terminal device issue a wireless tag. This promotes the use of the wireless tag. In addition, reflecting a request of a user of the second terminal device, product data is stored in the wireless tag. Thus, the second terminal device does not need to inquire of the first terminal device as to the product data. Accordingly, the load on communications between the first and second terminal devices can be reduced.

According to the first embodiment of the present invention, an excess memory area is bought and sold by way of the central apparatus. When some memory area is sold, a write access to the memory area is restricted. As a result, the excess memory area can be utilized and in addition, the area can be sold to thereby reduce the burden on a user issuing a wireless tag. Further, after the restriction on the access to write data to the memory area is cancelled, a user of the second terminal device can write product data desired by a third person on a part of the memory area and also resell the rest of the excess area.

According to the first embodiment of the present invention, data on the product data category and data on a price in return for an access to read the product data are sent/received. Hence, an extra value can be added to product data itself in the memory unit of the wireless tag, and the wireless tag can efficiently spread.

### Second Embodiment

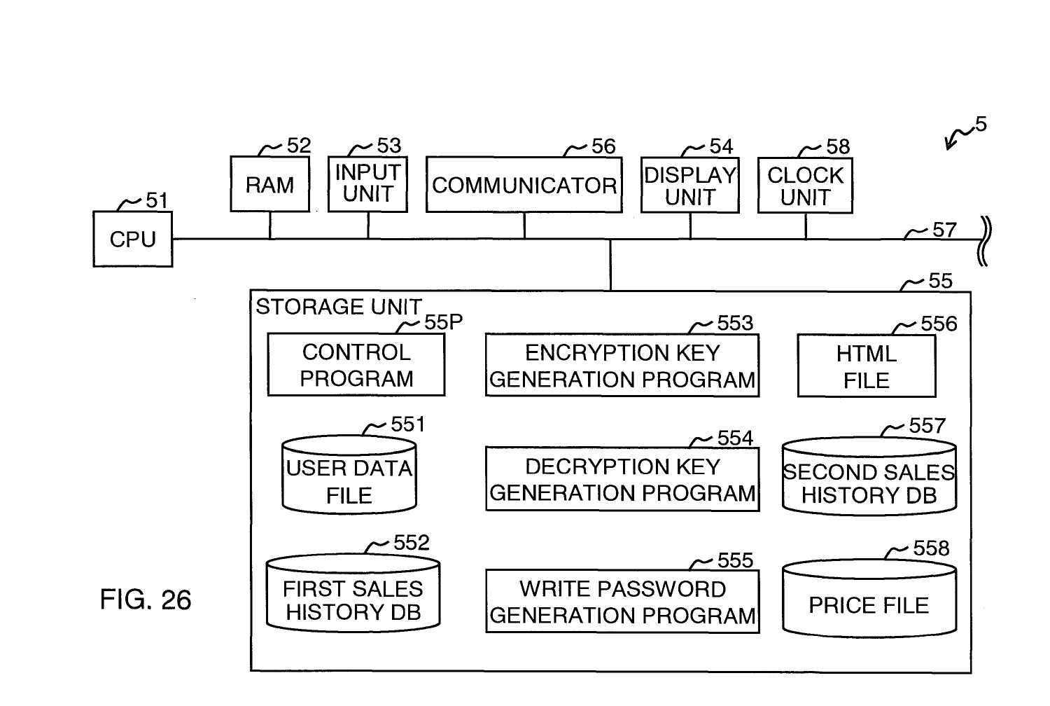

In a second embodiment of the present invention, the client 2 as one terminal device and the client 3 as the other terminal device purchase an area for sale through bidding. Since the areas for sale are limited, it is preferred to sell the areas to higher bidder. FIG. 26 is a block diagram illustrating a hardware configuration of the web server 5 according to a second embodiment of the present invention. As most configuration and operation of the second embodiment are similar to those of the first embodiment, like components are denoted by like reference numerals and detailed description thereof is omitted. In addition to the configuration of the first embodiment, a price file 558 for storing a bidding result is included in the storage unit 55. The price file 558 will be discussed in detail below. In the second embodiment, the clients 2 and 3 participate in bidding, but the present invention is not restricted thereto, and more clients may participate in bidding.

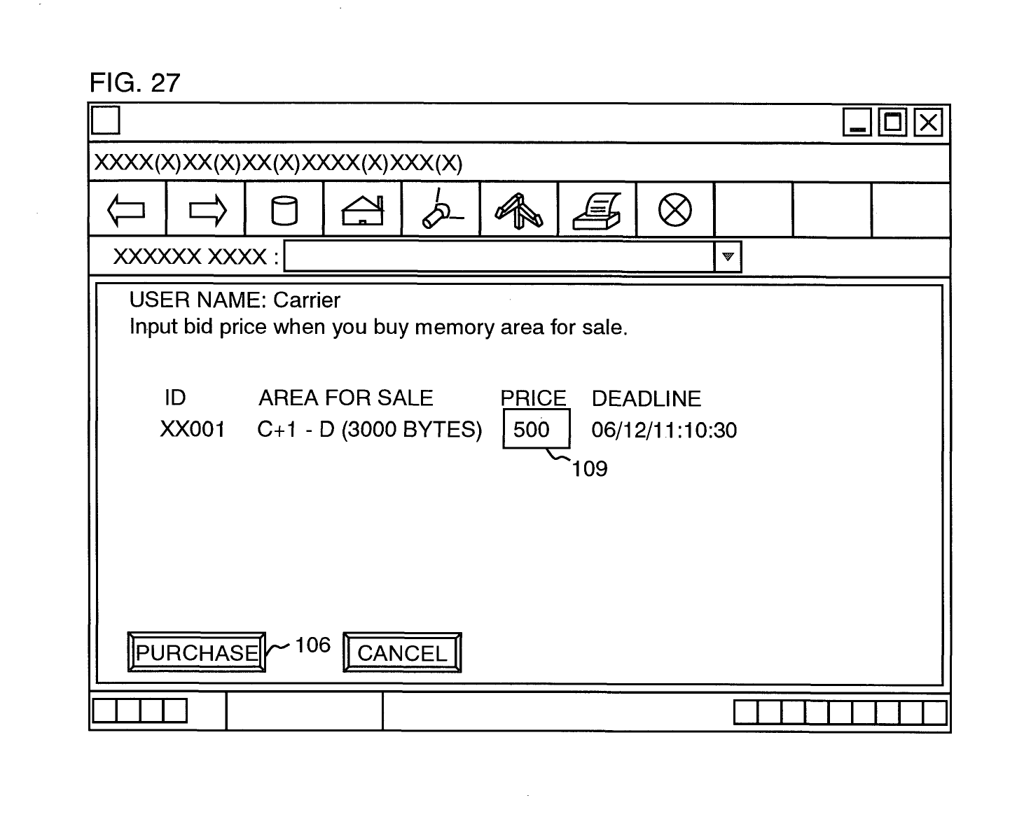

FIG. 27 is a diagram illustrating a screen image for a purchase of an area for sale according to a second embodiment of the present invention. The CPU 51 of the web server 5 writes an ID, area for sale, and deadline to template data read from the HTML file 556 to make screen data of a screen image for a bid on an area for sale such as shown in FIG. 27, and sends the screen data to the clients 2 and 3. FIG. 27 shows a screen image displayed on the browser 251 of the client 2 operated by a carrier. The carrier inputs a bid price to the price box 109 via the input unit 23. The CPU 21 sends the price input via the input unit 23, the ID, area for sale, and deadline to the web server 5. Likewise, a retailer sends the price, ID, area for sale, and deadline from the client 3.

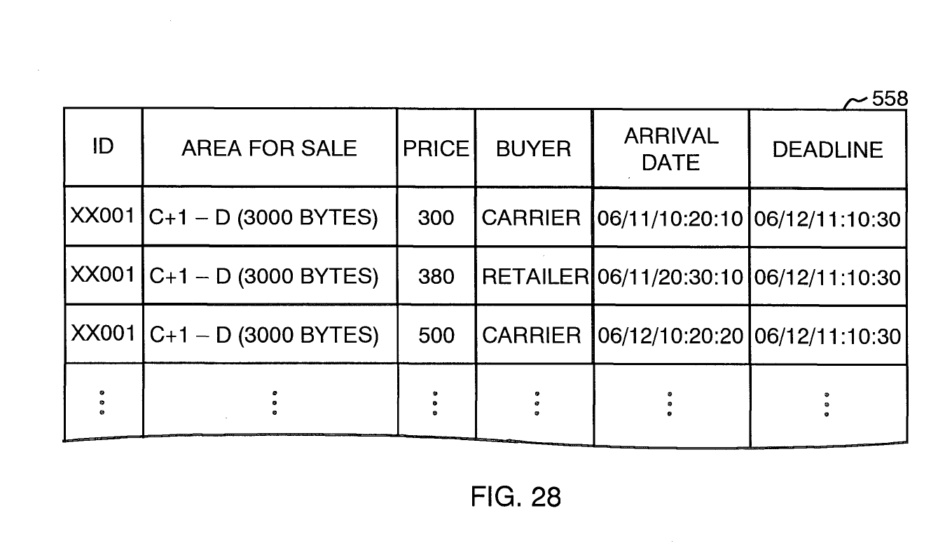

The web server 5 stores the price, ID, area for sale, and deadline sent from each of the clients 2 and 3 together with the data of date and time output from the clock unit 58 in association with buyer data in the price file 558 as a history record. FIG. 28 is a diagram illustrating a record layout of the price file 558 according to a second embodiment of the present invention. A record of the price file 558 includes an “ID” field, an “area for sale” field, a “price” field, a “buyer” field, an “arrival date” field, and a “deadline” field. The “ID” field stores the ID sent from the client 2 or 3, and the “area for sale” field stores address data of the area for sale in association with the ID.

The “price” field stores the bid price sent from the client 2 or 3. The “buyer” field stores a buyer name corresponding to the client 2 or 3 that has sent the bid price. The “arrival date” field stores data of date and time when the above data is received from the client 2 or 3. The “deadline” field stores the date and time corresponding to the valid term set by the client 1, that is, the deadline sent from the client 2 or 3 in association with the ID and price. The CPU 51 references data of date and time output from the clock unit 58 and checks whether the deadline stored in the price file 558 is reached as needed. When the deadline is reached, the CPU 51 extracts a buyer who bids the highest price of the prices stored in the “price” fields. In the example of FIG. 28, when the deadline, June 12, 11:10:30 is reached, the carrier who bids 500 yen is determined as a winner.

The CPU 51 stores the price in the “price” field of the second sales history DB 557 shown in FIG. 14 and stores end date in the “end date” field with reference to the data of date and time output from the clock unit 58. The CPU 51 reads an e-mail address of the extracted buyer from the user data file 551. The CPU 51 starts the write password generation program 555 to generate a write password to be sent to the clients 1 and 2. Then, as in the first embodiment, the CPU 51 sends to the read e-mail address of the carrier, an e-mail including a message to the effect that a sales contract is made, the generated write password, and the corresponding ID and area for sale stored in the second sales history DB 557. If a retailer bids the highest price, the e-mail is sent to the client 3.

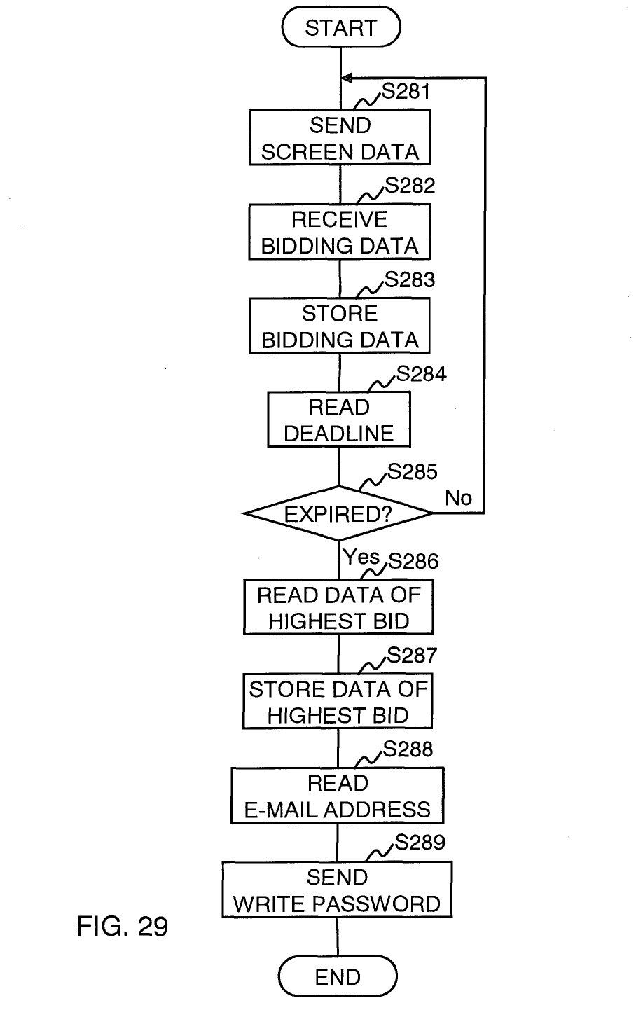

FIG. 29 is a diagram illustrating a flowchart of a bidding process according to a second embodiment of the present invention. The CPU 51 of the web server 5 generates screen data of a screen image for a purchase of an area for sale including all data but a price in accordance with the processing of the first embodiment, and sends the screen data to the clients 2 and 3 (operation S281). The screen data may be sent when the client 2 or 3 accesses the web server 5. Next, the CPU 51 receives bidding data including the ID, area for sale, price, and deadline sent from the client 2 or 3 (operation S282).

In order to store histories, the CPU 51 stores the bidding data including the ID, area for sale, price, arrival date, and deadline in the price file 558 in association with the data of the client 2 or 3 (carrier or retailer) as shown in FIG. 28 (operation S283). In the example of FIG. 28, two history records of the carrier operating the client 2 and one history record of the retailer operating the client 3 are stored. In the second embodiment, for ease of explanation, the “price” field stores a user name like a carrier and a retailer, but may store IP address of the client 2 or 3 instead.

The CPU 51 reads the deadline from the price file 558 or the second sales history DB 557 (operation S284), and determines whether the deadline is reached at this time with reference to the data of date and time output from the clock unit 58 (operation S285). If not reached (No in operation S285), the CPU 51 returns the process to operation S281 to repeat the above process until the deadline.

On the other hand, if reached (Yes in operation S285), the CPU 51 reads the highest price and the winner thereof from the price file 558 (operation S286). The CPU 51 stores the highest price in the “price” field of the second sales history DB 557, stores the winner in the “buyer” field, and stores the current date and time in the “end date” field (operation S287). The CPU 51 reads an e-mail address corresponding to the winner from the user data file 551 (operation S288). The CPU 51 starts the write password generation program 555 to generate a write password to be sent to the clients 1 and 2. Similar to the first embodiment, the CPU 51 sends to the read e-mail address of the carrier, an e-mail including a message to the effect that a sales contract is made, the generated write password, and corresponding ID and area for sale stored in the second sales history DB 557 (operation S289). In this way, the sales contract is made between the clients 1 and 2 or between the clients 1 and 3.

According to the second embodiment of the present invention, the central apparatus receives and stores data on a price in return for an access to write data to a memory area, from the second terminal device and the other terminal devices. If the deadline is reached, the central apparatus determines a terminal device corresponding to the highest price of the stored prices. The central apparatus sends a cancel key to the terminal device as the highest bidder. As a result, restricted memory areas can be bought and sold at a higher price.

### Third Embodiment

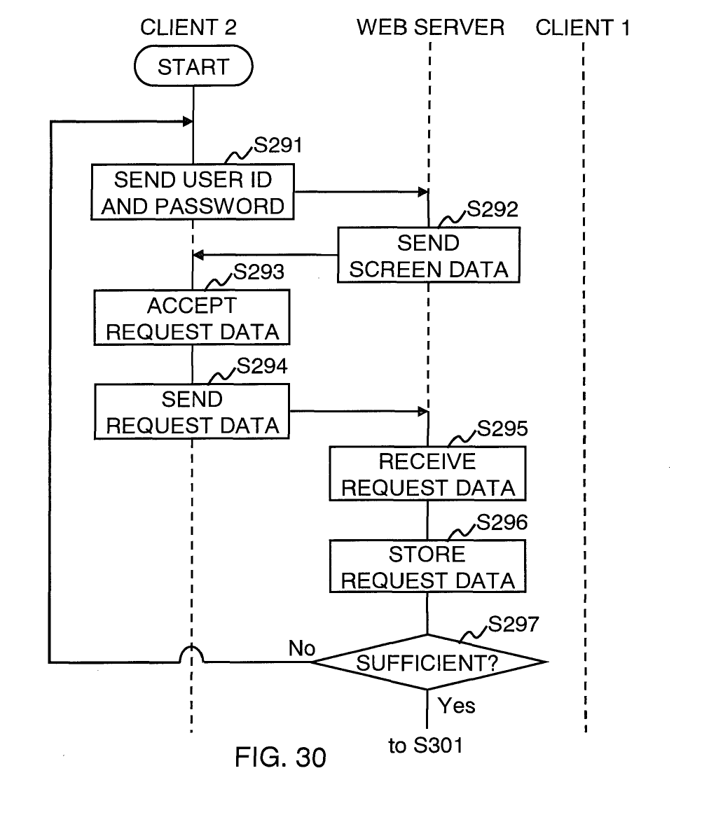

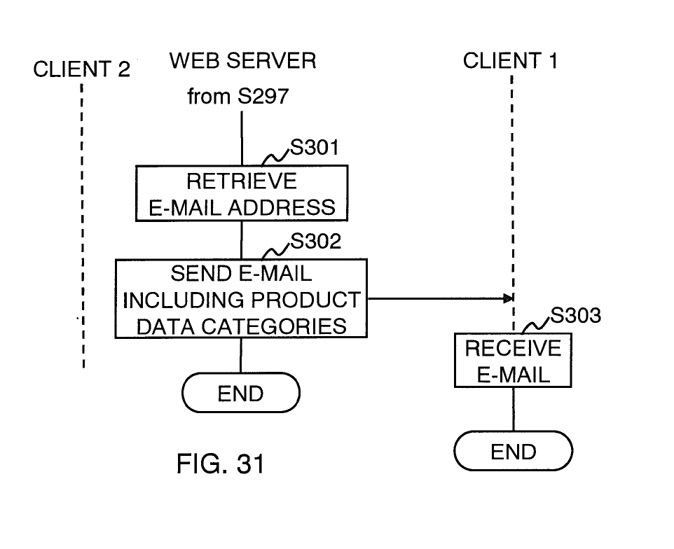

In a third embodiment of the present invention, desired product data category is sent to a client at the upstream site from the client 2 or 3 positioned at the downstream site. FIGS. 30 and 31 are diagrams illustrating a flowchart of a send process of desired product data category according to a third embodiment of the present invention. As most configuration and operation of the third embodiment are similar to those of the first and second embodiments, detailed description of like operation is omitted. In the third embodiment, a desired product data category is sent from the client 2 at the downstream site to the client 1 at the upstream site. The client 2 accesses the web server 5 to send a user ID and password to the web server 5 (operation S291). The CPU 51 of the web server 5 authenticates the user ID and password and then reads from the HTML file 556 screen data of a screen image for inputting desired product data and sends the screen data to the client 2 (operation S292).

The screen image for the desired product data input screen is displayed on the browser 251 of the client 2. The user inputs request data including a seller (in the third embodiment, beer producer) and a desired product data category via the input unit 23. The CPU 21 accepts the request data including the seller and desired product data category (operation S293) and sends the request data to the web server 5 (operation S294). The CPU 51 of the web server 5 receives the request data including the seller and desired product data category (operation S295). The CPU 51 stores the request data including the seller and desired product data category as a history record in the storage unit 55 as needed (operation S296).

The CPU 51 determines whether a predetermined number of history records are stored in the storage unit 55 in operation S296 (operation S297). The predetermined number is, for example, 100 and prestored in the storage unit 55. If it is unnecessary to repeatedly store the history records, the predetermined number may be set to 1. When a predetermined number of history records has not been stored (No in operation S297), the CPU 51 advances operation S291 and repeats the above process. In other words, the CPU 51 accumulates data about the desired product data categories requested to the seller, which are sent from the client 2 and the other clients including the client 3. As the capacity of the product data section 653 is limited, this helps the seller in recognizing product data that suits a need.

When the predetermined number of history records are stored (Yes in operation S297), the CPU 51 extracts an e-mail address of the seller received in operation S295 from the user data file 551 (operation S301). The CPU 51 searches the history records stored in the storage unit 55 for some product data categories that rank high, starts the mailer, writes the high ranked product data categories in an e-mail, and sends the e-mail to the e-mail address extracted in operation S301 (operation S302). More specifically, the history records in the storage unit 55 are referenced to count the number of received history records for each desired product data category to select a predetermined number (for example, 2) of the product data categories with larger count value. The CPU 11 of the client 1 as a seller receives the e-mail via the communicator 16 (operation S303). For example, if the number of received data on materials or calories as the product data category is larger than the number of received data on production date and container data as the product data categories stored as the initial product data, the beer producer is informed of the fact. Thus, the beer producer positioned at the upstream site may encrypt and store the higher-valued product data, which may bring in money in return and promote the use of the wireless tag 6.

According to the third embodiment of the present invention, the central apparatus receives data on a desired product data category from the second terminal device and sends the received data on the product data category to the first terminal device. As a result, the first terminal device can know the product data category to be stored in advance and the wireless tag can be further utilized. In this way, the present invention produces beneficial effects.

### Fourth Embodiment

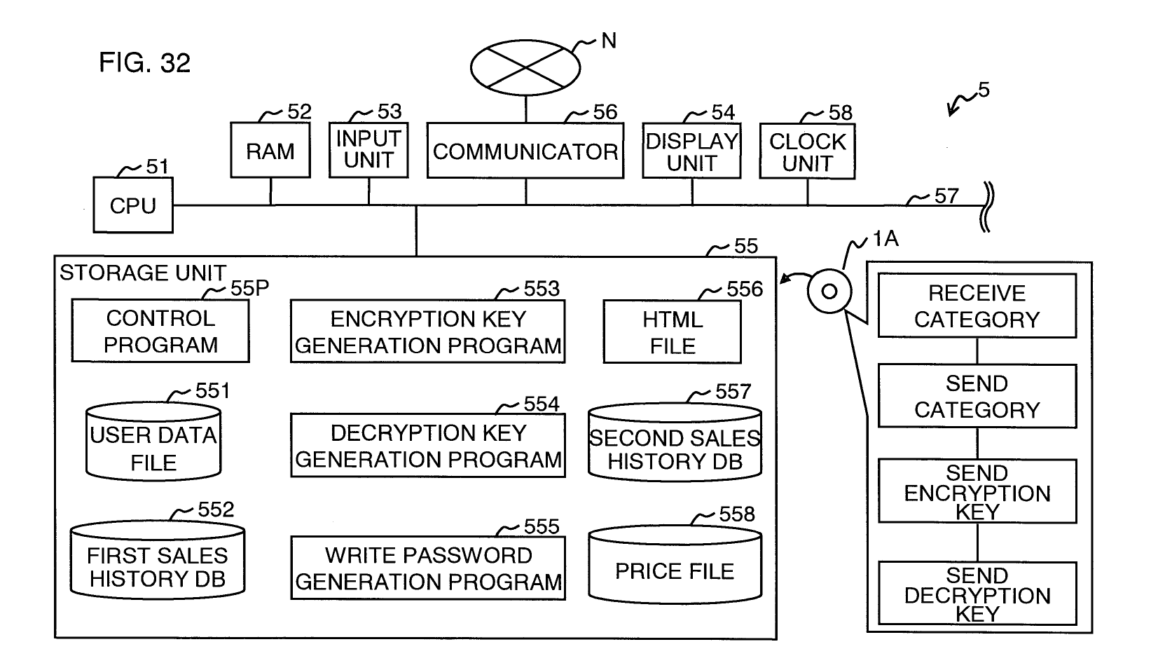

FIG. 32 is a block diagram illustrating a hardware configuration of the web server 5 according to a fourth embodiment of the present invention. As most configuration and operation of the fourth embodiment are similar to those of the first to third embodiments, like components are denoted by like reference numerals and detailed description thereof is omitted. A program for running the web server 5 of the fourth embodiment can be provided in the form of portable recording medium 1A such as a CD-ROM as in the fourth embodiment. Further, a computer program may be downloaded from a server computer (not shown) through a communication network N. This will be discussed in detail below.

A storage medium reader (not shown) of the web server 5 of FIG. 32 receives data of product data category and sends the data of product data category as well as an encryption key. The portable recording medium 1A storing a program for sending a decryption key is inserted to install the program to the control program 55P of the storage unit 55. Alternatively, this program may be downloaded from an external server computer (not shown) via the communicator 56 and installed to the storage unit 55. This program is loaded to the RAM 52 and executed to realize the function of the above web server 5.

What is claimed is:

1. A method executed by a system including terminal devices and a central apparatus connected to the terminal devices through a communication network, said central apparatus sending and receiving data in accordance with a request from one of the terminal devices, said method comprising:
sending by a first terminal device to the central apparatus first data indicating a first category of data for sale among categories of data to be stored in a memory unit of a wireless tag;
receiving by the central apparatus the first data;
sending by the central apparatus the first data to a second terminal device;
sending by the second terminal device second data indicating purchase of data of the first category;
sending by the central apparatus an encryption key to the first terminal device on receiving the second data;
encrypting by the first terminal device the data of the first category with the encryption key;
writing by the first terminal device encrypted data of the first category to the memory unit of the wireless tag;
sending by the central apparatus a decryption key to the second terminal device;
reading by the second terminal device the encrypted data of the first category from the memory unit of the wireless tag; and
decrypting by the second terminal device the encrypted data of the first category with the decryption key.

2. The method of claim 1, said method further comprising:
sending by the first terminal device third data indicating a memory area for sale within the memory unit of the wireless tag;
receiving by the central apparatus the third data,
sending by the central apparatus the third data to the second terminal device;
sending by the second terminal device fourth data indicating purchase of the memory area;
sending by the central apparatus a restriction key to the first terminal device on receiving the fourth data;
restricting by the first terminal device a write access to the memory area with the restriction key;
sending by the central apparatus a cancel key to the second terminal device; and
canceling by the second terminal device the restriction of a write access to the memory area with the cancel key.

3. A system for sending and receiving data relating to a memory unit of a wireless tag, comprising:
a central apparatus;
a first terminal device connected to the central apparatus through a communication network; and
a second terminal device connected to the central apparatus through a communication network,
wherein
said central apparatus including:
a data receiver for receiving from the first terminal device first data indicating a first category of data for sale among categories of data to be stored in the memory unit,
a data transmitter for sending the first data to the second terminal device,
an encryption key transmitter for sending an encryption key to the first terminal device on receiving from the second terminal device second data indicating purchase of data of the first category, and
a decryption key transmitter for sending a decryption key to the second terminal device,
said first terminal device including:
an encryptor for
encrypting the data of the first category with the encryption key
received from the central apparatus, and
writing encrypted data of the first category to the memory unit of the wireless tag, and
said second terminal device including:
a decryptor for
reading the encrypted data of the first category from the memory unit of the wireless tag, and
decrypting the encrypted data of the first category with the decryption key received from the central apparatus.

4. The system of claim 3, wherein
said central apparatus further includes:
an area data receiver for receiving from the first terminal device third data indicating a memory area for sale within the memory unit of the wireless tag,
an area data transmitter for sending the third data to the second terminal device,
a restriction key transmitter for sending a restriction key to the first terminal device on receiving from the second terminal device fourth data indicating purchase of the memory area, and
a cancel key transmitter for sending a cancel key to the second terminal device,
said first terminal device further includes:
a restrictor for restricting a write access to the memory area with the restriction key received from the central apparatus, and
said second terminal device further includes:
a canceller for canceling the restriction of a write access to the memory area with the cancel key received from the central apparatus.

5. A central apparatus connected to terminal devices through a communication network, said central apparatus sending and receiving data in accordance with a request from one of the terminal devices, said central apparatus comprising:
a data receiver for receiving from a first terminal device first data indicating a first category of data for sale among categories of data to be stored in a memory unit of a wireless tag;
a data transmitter for sending the first data to a second terminal device;
an encryption key transmitter for sending, on receiving from the second terminal device, second data indicating purchase of data of the first category, to the first terminal device an encryption key for encrypting data of the first category; and
a decryption key transmitter for sending to the second terminal device a decryption key for decrypting encrypted data of the first category.

6. The central apparatus of claim 5, further comprising:
an area data receiver for receiving from the first terminal device third data indicating a memory area for sale within the memory unit of the wireless tag;
an area data transmitter for sending the third data to the second terminal device;
a restriction key transmitter for sending, on receiving from the second terminal device fourth data indicating purchase of the memory area, to the first terminal device a restriction key for restricting a write access to the memory area; and
a cancel key transmitter for sending to the second terminal device a cancel key canceling the restriction of a write access to the memory area.

7. A computer readable storage medium storing a program of instructions to a computer connected to terminal devices through a communication network, said instructions being for executing a method for sending and receiving data in accordance with a request from one of the terminal devices, said method comprising:
receiving from a first terminal device first data indicating a first category of data for sale among categories of data to be stored in a memory unit of a wireless tag;
sending the first data to a second terminal device;
sending, on receiving from the second terminal device second data indicating purchase of data of the first category, to the first terminal device an encryption key for encrypting data of the first category; and
sending to the second terminal device a decryption key for decrypting encrypted data of the first category.

8. The computer readable storage medium of claim 7, said method further comprising:
receiving from the first terminal device third data indicating a memory area for sale within the memory unit of the wireless tag;
sending the third data to the second terminal device;
sending, on receiving from the second terminal device fourth data indicating purchase of the memory area, to the first terminal device a restriction key for restricting a write access to the memory area; and
sending to the second terminal device a cancel key canceling the restriction of a write access to the memory area.

9. The computer readable storage medium of claim 8, said computer having a storage unit, said method further comprising:
sending the first data to a third terminal device;
receiving from the second terminal device first price data indicating a bid price for the purchase of the memory area;
storing in the storage unit the first price data in association with the second terminal device;
receiving from the third terminal device second price data indicating a bid price for the purchase of the memory area;
storing in the storage unit the second price data in association with the third terminal device;
reading from the storage unit deadline data indicating a deadline date for bidding; and
determining, on the deadline date expiring, a winner bidding a higher price, on the basis of the first price data and the second price data stored in the storage unit, between the second terminal device and the third terminal device,
wherein
said operation of sending the restriction key to the first terminal device is executed on determining the winner, and
in said operation of sending the cancel key, the cancel key is sent to the winner.

10. The computer readable storage medium of claim 7, wherein
in the operation of receiving the first data from the first terminal device, a price data indicating an asking price for the data of the first category is also received from the first terminal device, and
in the operation of sending the first data to the second terminal device, the price data is also sent to the second terminal device.

11. The computer readable storage medium of claim 7, said method further comprising:
receiving from the second terminal device fifth data indicating a second category of data desired; and
sending the fifth data to the first terminal device.
